(19) United States
(12) Patent Application Publication
(10) Pub. No.: US 2020/0058941 A1
(43) Pub. Date: Feb. 20, 2020

(54) SECONDARY BATTERY, BATTERY PACK, ELECTRIC VEHICLE, ELECTRIC TOOL AND ELECTRONIC DEVICE

(71) Applicant: MURATA MANUFACTURING CO., LTD., Kyoto (JP)

(72) Inventors: Naoki HAYASHI, Kyoto (JP); Yasuhiro IKEDA, Kyoto (JP)

(21) Appl. No.: 16/535,589

(22) Filed: Aug. 8, 2019

Related U.S. Application Data
(63) Continuation of application No. PCT/JP2017/036820, filed on Oct. 11, 2017.

(30) Foreign Application Priority Data
Feb. 9, 2017 (JP) 2017-021883
Jun. 8, 2017 (JP) 2017-113451
Aug. 29, 2017 (JP) 2017-164381

(51) Int. Cl. H01M 4/62; H01M 4/60; H01M 4/583; H01M 4/38

(52) U.S. Cl. CPC H01M 4/625; H01M 4/623; H01M 2004/027; H01M 4/5835; H01M 4/386; H01M 4/60

(57) ABSTRACT

A secondary battery includes a positive electrode, a negative electrode, and an electrolytic solution, and the negative electrode includes a first negative electrode active substance, a second negative electrode active substance, and a negative electrode binder. The first negative electrode active substance includes a central portion containing a material containing silicon as a constituent element, and a covering portion provided on a surface of the central portion and containing a salt compound and a conductive substance. The salt compound contains at least one of polyacrylate and carboxymethylcellulose salt, and the conductive substance contains at least one of a carbon material and a metal material. The second negative electrode active substance contains a material containing carbon as a constituent element. The negative electrode binder contains at least one type of polyvinylidene fluoride, polyimide, and aramid.

### TECHNICAL FIELD

The present technology relates to a secondary battery using a negative electrode, and a battery pack, an electric vehicle, an electric tool, and an electronic device using the secondary battery.

### BACKGROUND ART

Various electronic devices such as mobile phones and personal digital assistants (PDAs) are widely used, and there is a demand for downsizing, weight reduction, and long life of the electronic devices. Therefore, as a power source, development of a battery, in particular, a small and lightweight secondary battery capable of obtaining high energy density has been promoted.

The secondary battery is not limited to the above-mentioned electronic devices, and its application to other applications is also considered. For example, there are given a battery pack detachably mounted on an electronic device or the like, an electric vehicle such as an electric car, a power storage system such as a household power server, and an electric tool such as an electric drill.

The secondary battery includes an electrolytic solution together with a positive electrode and a negative electrode, and the negative electrode contains a negative electrode active substance, a negative electrode binder, and the like. Since the configuration of the negative electrode has a great effect on battery characteristics, various studies have been made regarding the configuration of the negative electrode.

Specifically, in order to improve cycle characteristics and the like, active substance grains are granulated using a granulation binder such as polyacrylic (see, for example, Patent Document 1).

### PRIOR ART DOCUMENT

### Patent Document

Patent Document 1: Japanese Patent Application Laid-Open No. 2013-235684

### SUMMARY OF THE INVENTION

Electronic devices and the like are becoming increasingly sophisticated and multifunctional. Along with this, the frequency of use of electronic devices and the like is increasing, and the use environment of electronic devices and the like is expanding. Therefore, the battery characteristics of the secondary battery still have room for improvement.

Therefore, it is desirable to provide a secondary battery, a battery pack, an electric vehicle, an electric tool, and an electronic device capable of obtaining excellent battery characteristics.

A secondary battery according to an embodiment of the present technology includes a positive electrode, a negative electrode, and an electrolytic solution, and the negative electrode includes a first negative electrode active substance, a second negative electrode active substance, and a negative electrode binder. The first negative electrode active substance includes a central portion containing a material containing silicon (Si) as a constituent element, and a covering portion provided on a surface of the central portion and containing a salt compound and a conductive substance. The salt compound contains at least one of polyacrylate and carboxymethylcellulose salt, and the conductive substance contains at least one of a carbon material and a metal material. The second negative electrode active substance contains a material containing carbon (C) as a constituent element. The negative electrode binder contains at least one of polyvinylidene fluoride, polyimide and aramid.

Each of the battery pack, the electric vehicle, the electric tool, and the electronic device of an embodiment of the present technology includes a secondary battery, and the secondary battery has the same configuration as the above-mentioned secondary battery of the embodiment of the present technology.

According to the secondary battery of the embodiment of the present technology, the negative electrode includes the first negative electrode active substance, the second negative electrode active substance, and the negative electrode binder, and each of the first negative electrode active substance, the second negative electrode active substance, and the negative electrode binder has the above-mentioned configuration, so that excellent battery characteristics can be obtained. The same effect can be obtained in each of the battery pack, the electric vehicle, the electric tool, and the electronic device of the embodiment of the present technology.

In addition, the effect described here is not necessarily limited, and may be any effect described in the present technology.

### BRIEF EXPLANATION OF DRAWINGS

FIG. 1 is a cross-sectional view illustrating a configuration of a negative electrode for a secondary battery according to an embodiment of the present technology.

FIG. 2 is a cross-sectional view schematically illustrating configurations of a first negative electrode active substance and a second negative electrode active substance.

FIG. 3 is a cross-sectional view schematically illustrating a configuration of a composite grain.

FIG. 4 is a plan view schematically illustrating a configuration of a three-dimensional network structure formed of a plurality of first negative electrode active substances.

FIG. 5 is an enlarged cross-sectional view illustrating a configuration of a connection portion illustrated in FIG. 4.

FIG. 6 is a cross-sectional view illustrating a configuration of a secondary battery (cylindrical type) according to an embodiment of the present technology.

FIG. 7 is an enlarged cross-sectional view illustrating a part of a configuration of a wound electrode body illustrated in FIG. 6.

FIG. 8 is a perspective view illustrating a configuration of a secondary battery (laminated film type) according to an embodiment of the present technology.

FIG. 9 is a cross-sectional view illustrating a configuration of a wound electrode body taken along the line IX-IX illustrated in FIG. 8.

FIG. 10 is a perspective view illustrating a configuration of an application example (battery pack: single cell) of the secondary battery.

FIG. 11 is a block diagram illustrating a configuration of the battery pack illustrated in FIG. 10.

FIG. 12 is a block diagram illustrating a configuration of an application example (battery pack: assembled battery) of the secondary battery.

FIG. 13 is a block diagram illustrating a configuration of an application example (electric vehicle) of the secondary battery.

FIG. 14 is a block diagram illustrating a configuration of an application example (power storage system) of the secondary battery.

FIG. 15 is a block diagram illustrating a configuration of an application example (electric tool) of the secondary battery.

FIG. 16 is a cross-sectional view illustrating a configuration of a test secondary battery (coin type).

### MODE FOR CARRYING OUT THE INVENTION

Hereinafter, an embodiment of the present technology will be described in detail with reference to the drawings. The description order is as follows.

1. Negative electrode for secondary battery
1-1. Configuration
1-2. Manufacturing method
1-3. Action and effect

2. Secondary battery
2-1. Lithium ion secondary battery (cylindrical type)
2-2. Lithium ion secondary battery (laminated film type)

3. Application of secondary battery
3-1. Battery pack (single cell)
3-2. Battery pack (assembled battery)
3-3. Electric vehicle
3-4. Power storage system
3-5. Electric tool

### <1. Negative Electrode for Secondary Battery>

First, a negative electrode for a secondary battery according to an embodiment of the present technology will be described.

The negative electrode for a secondary battery (hereinafter, simply referred to as “negative electrode”) described here is used for, for example, a secondary battery. Although the type of secondary battery for which the negative electrode is used is not particularly limited, there is given, for example, a lithium ion secondary battery.

### <1-1. Configuration>

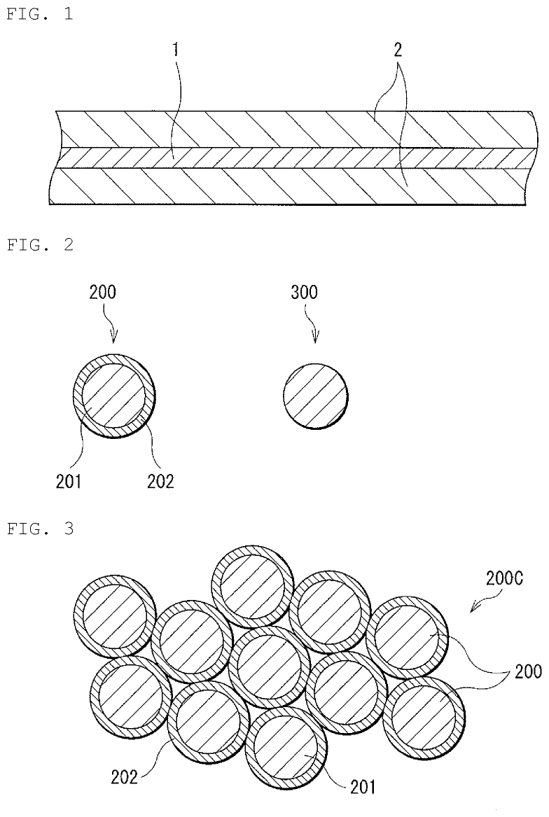

FIG. 1 illustrates a cross-sectional configuration of the negative electrode. The negative electrode includes, for example, a negative electrode current collector 1 and negative electrode active substance layers 2 provided on the negative electrode current collector 1.

The negative electrode active substance layer 2 may be provided only on one side of the negative electrode current collector 1 or may be provided on both sides of the negative electrode current collector 1. FIG. 1 illustrates, for example, the case where the negative electrode active substance layers 2 are provided on both sides of the negative electrode current collector 1.

### [Negative Electrode Current Collector]

The negative electrode current collector 1 contains, for example, any one or two or more types of conductive material. The type of conductive material is not particularly limited, examples thereof include copper (Cu), aluminum (Al), nickel (Ni), and stainless steel, and it may be an alloy. The negative electrode current collector 1 may be a single layer or a multilayer.

The surface of the negative electrode current collector 1 is preferably roughened. This is because the close contact property of the negative electrode active substance layer 2 to the negative electrode current collector 1 is improved by a so-called anchor effect. In this case, it is only necessary that the surface of the negative electrode current collector 1 be roughened at least in a region opposed to the negative electrode active substance layer 2. The method of roughening is, for example, a method of forming fine grains using electrolytic treatment. In the electrolytic treatment, since fine grains are formed on the surface of the negative electrode current collector 1 in an electrolytic cell by the electrolytic method, irregularities are provided on the surface of the negative electrode current collector 1. A copper foil produced by the electrolytic method is generally called an electrolytic copper foil.

### [Negative Electrode Active Substance Layer]

The negative electrode active substance layer 2 contains two types of negative electrode active substance (a first negative electrode active substance 200 and a second negative electrode active substance 300) capable of occluding and extracting an electrode reactant, and a negative electrode binder. The negative electrode active substance layer 2 may be a single layer or a multilayer.

The “electrode reactant” is a substance involved in a charge/discharge reaction of the secondary battery. Specifically, an electrode reactant used in a lithium ion secondary battery is lithium.

FIG. 2 schematically illustrates cross-sectional configurations of the first negative electrode active substance 200 and the second negative electrode active substance 300. The negative electrode active substance layer 2 contains, for example, a plurality of first negative electrode active substances 200 and a plurality of second negative electrode active substances 300.

The first negative electrode active substance 200 includes a central portion 201 containing a silicon-based material described later, and a covering portion 202 provided on the surface of the central portion 201. The second negative electrode active substance 300 contains a carbon-based material described later.

The reason why the negative electrode active substance layer 2 contains the first negative electrode active substances 200 and the second negative electrode active substances 300 is that the negative electrode is difficult to expand and contract during charge and discharge and an electrolytic solution is difficult to decompose while securing a high theoretical capacity (in other words, battery capacity).

Specifically, the carbon-based material contained in the second negative electrode active substance 300 has an advantage of being difficult to expand and contract during charge and discharge and being difficult to decompose an electrolytic solution, but has a concern of having a low theoretical capacity. On the other hand, the silicon-based material contained in the central portion 201 of the first negative electrode active substance 200 has an advantage of having a high theoretical capacity, but has a concern of being easily to expand and contract during charge and discharge and being easy to decompose an electrolytic solution. Therefore, by using the first negative electrode active substances 200 containing a silicon-based material and the second negative electrode active substances 300 containing a carbon-based material in combination, a high theoretical capacity is obtained, and at the same time, expansion and contraction of the negative electrode are suppressed during charge and discharge, and the decomposition reaction of the electrolytic solution is suppressed.

The mixing ratio (weight ratio) of the first negative electrode active substances 200 to the second negative electrode active substances 300 is not particularly limited, but, for example, the first negative electrode active substances 200: the second negative electrode active substances 300=1:99 to 99:1. If the first negative electrode active substances 200 and the second negative electrode active substances 300 are mixed, there is obtained an advantage of using the first negative electrode active substances 200 and the second negative electrode active substances 300 in combination as described above regardless of the mixing ratio.

In particular, the mixing ratio of the first negative electrode active substances 200 containing a silicon-based material is preferably smaller than the mixing ratio of the second negative electrode active substances 300 containing a carbon-based material. Specifically, the mixing ratio (weight ratio) of the first negative electrode active substances 200 to the second negative electrode active substances 300 is preferably the first negative electrode active substance 200: the second negative electrode active substance 300=5:95 to 40:60. Since the ratio of the silicon-based material, which is the main cause of expansion and contraction of the negative electrode, is relatively reduced, expansion and contraction of the negative electrode can be sufficiently suppressed and the decomposition reaction of the electrolytic solution can be sufficiently suppressed.

The negative electrode active substance layer 2 is formed, for example, by any one or two or more types of method such as a coating method. In the coating method, for example, a dispersion liquid (slurry) containing negative electrode active substances in a grain (powder) shape, a negative electrode binder, an aqueous solvent, a non-aqueous solvent (for example, an organic solvent), and the like is prepared, and then the dispersion liquid is coated on the negative electrode current collector 1.

In the secondary battery in which the negative electrode is used, in order to prevent the electrode reactant from being deposited unintentionally on the surface of the negative electrode during charging, the chargeable capacity of the negative electrode active substance is preferably larger than the discharge capacity of the positive electrode. In other words, the electrochemical equivalent of the negative electrode active substance capable of occluding and extracting the electrode reactant is preferably larger than the electrochemical equivalent of the positive electrode.

### (First Negative Electrode Active Substance)

As described above, the first negative electrode active substance 200 includes the central portion 201 and the covering portion 202.

The shape of the first negative electrode active substance 200 is not particularly limited, and is, for example, fibrous, spherical (particulate), scaly, or the like. FIG. 2 illustrates, for example, the case where the shape of the first negative electrode active substance 200 is spherical. As a matter of course, the first negative electrode active substances 200 having two or more types of shape may be mixed.

FIG. 3 schematically illustrates a cross-sectional configuration of a composite grain 200C. When the negative electrode active substance layer 2 contains the plurality of first negative electrode active substances 200, the plurality of first negative electrode active substances 200 are preferably in close contact with each other to form an aggregate (composite grain 200C) as illustrated in FIG. 3. The composite grain 200C is a structure formed by granulating the plurality of first negative electrode active substances 200. The number of the composite grains 200C included in the negative electrode active substance layer 2 is not particularly limited, and may be only one or two or more. FIG. 3 illustrates one composite grain 200C.

The composite grain 200C described here is not merely an aggregate of the plurality of first negative electrode active substances 200. The composite grain 200C is a structure formed by the plurality of first negative electrode active substances 200 being strongly connected to each other via the covering portions 202 that function as a binder.

When the plurality of first negative electrode active substances 200 form the composite grain 200C, a migration path (occluding and releasing path) for the electrode reactant is secured inside the composite grain 200C. As a result, the electrical resistance of the composite grain 200C is reduced, and each central portion 201 contained in the composite grain 200C easily occludes and releases the electrode reactant. Therefore, even if charge and discharge are repeated, the secondary battery is less likely to swell and the discharge capacity is less likely to be reduced.

The number of the first negative electrode active substances 200 forming one composite grain 200C is not particularly limited. FIG. 3 illustrates, for example, a case where one composite grain 200C is formed of eleven first negative electrode active substances 200 in order to simplify the illustration. However, the negative electrode active substance layer 2 may contain the first negative electrode active substance 200 which is not involved in the formation of the composite grains 200C in addition to the composite grain 200C. That is, not all the first negative electrode active substances 200 need to form the composite grain 200C, and the first negative electrode active substance 200 not forming the composite grain 200C may be present.

The composite grain 200C is easily formed, for example, by using a specific method as a method of forming the first negative electrode active substance 200. This particular method is, for example, a spray dry method. The details of the method of forming the composite grain 200C will be described later.

The specific surface area of the composite grain 200C is not particularly limited, and is, for example, 0.1 m²/g to 10 m²/g. This is because, in the secondary battery using the negative electrode, the discharge capacity is secured, and the electrical resistance of the negative electrode is reduced. In detail, when the specific surface area is larger than 10 m²/g, since the specific surface area is too large, the loss of the discharge capacity may increase due to the occurrence of the side reaction. On the other hand, when the specific surface area is smaller than 0.1 m²/g, since the specific surface area is too small, the electrical resistance of the negative electrode at the time of high load may increase due to the lack of reaction area. The “specific surface area” described here is a so-called BET specific surface area.

### (Central Portion)

The central portion 201 contains any one or two or more types of silicon-based material. The “silicon-based material” is a generic term for materials containing silicon as a constituent element.

The central portion 201 contains the silicon-based material because the silicon-based material has an excellent ability to occlude and release the electrode reactant, so that a high energy density can be obtained.

The silicon-based material may be a single substance of silicon, an alloy of silicon, or a compound of silicon. In addition, the silicon-based material may be a material including a phase of any one or two or more types of above-mentioned single substance, alloy, and compound at at least a part thereof. The silicon-based material may be crystalline or amorphous, or may contain both a crystalline portion and an amorphous portion.

However, the “single substance” described here is a single substance in a general sense. That is, the purity of the single substance does not necessarily have to be 100%, and the single substance may contain a trace amount of impurities.

The alloy of silicon may contain two or more types of metal element as constituent elements, or may contain one or more types of metal element and one or more types of metalloid element as constituent elements. Further, the above-mentioned alloy of silicon may further contain one or more types of nonmetallic element as constituent elements. The structure of the alloy of silicon is, for example, a solid solution, a eutectic (eutectic mixture), an intermetallic compound, or a coexistence of two or more types thereof.

The metal element and the metalloid element contained in the alloy of silicon as constituent elements are, for example, any one or two or more types of metal element and metalloid element capable of forming an alloy with the electrode reactant. Specifically, there are given, for example, magnesium (Mg), boron (B), aluminum, gallium (Ga), indium (In), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt).

The alloy of silicon contains, for example, any one or two or more types of tin, nickel, copper, iron (Fe), cobalt (Co), manganese (Mn), zinc, indium (In), silver, titanium (Ti), germanium, bismuth, antimony (Sb), chromium (Cr), and the like as a constituent element other than silicon.

The compound of silicon contains, for example, any one or two or more types of carbon and oxygen (O) as a constituent element other than silicon. The compound of silicon may contain, for example, any one or two or more types of a series of elements described for the alloy of silicon as a constituent element other than silicon.

The alloy of silicon and the compound of silicon are, for example, SiB₄, SiB₆, Mg₂Si, Ni₂Si, TiSi₂, MoSi₂, CoSi₂, NiSi₂, CaSi₂, CrSi₂, Cu₅Si, FeSi₂, FeSi₂, MnSi₂, NbSi₂, TaSi₂, VSi₂, WSi₂, ZnSi₂, SiC, Si₃N₄, Si₂N₂O, SiOᵥ (0<v≤2), and LiSiO. Incidentally, v in SiOᵥ may be 0.2<v<1.4.

The details of the shape of the central portion 201 are, for example, the same as the details of the shape of the first negative electrode active substance 200 described above. That is, the shape of the central portion 201 is, for example, fibrous, spherical (particulate), scaly, or the like, and FIG. 2 illustrates, for example, the case where the shape of the central portion 201 is spherical. As a matter of course, the central portions 201 having two or more types of shape may be mixed.

When the shape of the central portion 201 is particulate, the average grain diameter of the central portion 201 is not particularly limited, and is, for example, about 1 μm to 10 μm. The “average grain diameter” described here is a so-called median diameter D50 (μm), and the same applies to the following.

### (Covering Portion)

The covering portion 202 is provided on a part or the entirety of the surface of the central portion 201. That is, the covering portion 202 may cover only a part of the surface of the central portion 201, or may cover the entirety of the surface of the central portion 201. As a matter of course, when the covering portion 202 covers a part of the surface of the central portion 201, the plurality of covering portions 202 are provided on the surface of the central portion 201, that is, the plurality of covering portions 202 may cover the surface of the central portion 201.

In particular, the covering portion 202 is preferably provided only on a part of the surface of the central portion 201. In this case, since the entirety of the surface of the central portion 201 is not covered by the covering portion 202, a part of the surface of the central portion 201 is exposed. As a result, the migration path (occluding and releasing path) for the electrode reactant is secured in the exposed portion of the central portion 201, so that the central portion 201 easily occludes and releases the electrode reactant. Therefore, even if charge and discharge are repeated, the secondary battery is less likely to swell and the discharge capacity is less likely to be reduced. The number of exposed portions may be only one or two or more.

The cover 202 contains a salt compound and a conductive substance. The number of types of salt compound may be only one or two or more. The number of types of conductive substance may be only one or two or more.

### (Salt Compound)

The salt compound contains one or both of polyacrylate and carboxymethylcellulose salt. This is because the coating film of the salt compound exhibits the same function as the solid electrolyte interphase (SEI) film. As a result, even if the covering portion 202 is provided on the surface of the central portion 201, the occlusion and release of the electrode reactant in the central portion 201 is not inhibited by the covering portion 202, and the decomposition reaction of the electrolytic solution caused by the reactivity of the central portion 201 is suppressed by the covering portion 202. In this case, in particular, the coating film of the salt compound is difficult to be decomposed even at the end of the discharge, so that the decomposition reaction of the electrolytic solution is sufficiently suppressed even at the end of the discharge.

The type of polyacrylate is not particularly limited. The number of types of this polyacrylate may be only one or two or more.

Specifically, polyacrylates contain, for example, metal salt and onium salt. However, the polyacrylate described herein is not limited to a compound in which all carboxyl groups (—COOH) contained in polyacrylic form salt, and may be a compound in which some of the carboxyl groups contained in the polyacrylic form salt. That is, the latter polyacrylate may contain one or two or more carboxyl groups.

The type of metal ion contained in the metal salt is not particularly limited, and is, for example, an alkali metal ion and the like, and the alkali metal ion is, for example, a lithium ion, a sodium ion, or a potassium ion. Specifically, the polyacrylate is, for example, lithium polyacrylate, sodium polyacrylate, or potassium polyacrylate.

The type of onium ion contained in the onium salt is not particularly limited, and is, for example, an ammonium ion or a phosphonium ion. Specifically, the polyacrylate is, for example, ammonium polyacrylate or phosphonium polyacrylate.

The polyacrylate may contain only a metal ion in one molecule, may contain only an onium ion, or may contain both. Also in this case, the polyacrylate may contain one or two or more carboxyl groups as described above.

The type of carboxymethylcellulose salt is not particularly limited. The number of types of carboxymethylcellulose salt may be one or two or more.

Specifically, carboxymethylcellulose salt contains, for example, metal salt. However, the carboxymethylcellulose salt described here is not limited to a compound in which all hydroxyl groups (—OH) contained in carboxymethylcellulose form salt, and may be a compound in which some of the hydroxyl groups contained in carboxymethylcellulose form salt. That is, the latter carboxymethylcellulose salt may contain one or two or more hydroxyl groups.

The type of metal ion contained in the metal salt is not particularly limited, and is, for example, an alkali metal ion and the like, and the alkali metal ion is, for example, a lithium ion, a sodium ion, or a potassium ion. Specifically, the carboxymethylcellulose salt is, for example, lithium carboxymethylcellulose, sodium carboxymethylcellulose, potassium carboxymethylcellulose, or the like.

### (Conductive Substance)

The conductive substance contains one or both of a carbon material and a metal material. This is because the carbon material and the metal material exhibit excellent conductivity in the state of being contained in the covering portion 202 (coating film of a salt compound). As a result, even if the covering portion 202 is provided on the surface of the central portion 201, the conductivity of the first negative electrode active substance 200 is secured. In this case, in particular, the conductivity is maintained by the conductive substance contained in each coating film of the salt compound even at the end of the discharge, so that the discharge capacity hardly decreases even at the end of the discharge.

The type of carbon material is not particularly limited. The number of types of carbon material may be only one or two or more.

Specifically, the carbon material is, for example, carbon nanotubes, carbon nanofibers, carbon black, or acetylene black. The average tube diameter of the carbon nanotubes is not particularly limited, but in particular, it is preferably 1 nm to 300 nm. It is because the conductivity is further improved. However, the carbon material may contain, for example, single-walled carbon nanotubes described later together with any one or two or more types of carbon nanotubes, carbon nanofibers, carbon black, and acetylene black described above.

Alternatively, the carbon material may be, for example, single-walled carbon nanotubes. The average tube diameter of the single-walled carbon nanotubes is not particularly limited, but in particular, it is preferably 0.1 nm to 5 nm. Further, the average length of the single-walled carbon nanotubes is not particularly limited, but in particular, it is preferably 5 μm to 100 μm. It is because the conductivity is further improved.

In particular, since the average tube diameter of the single-walled carbon nanotubes is smaller than the average tube diameter of the carbon nanotubes, using the single-walled carbon nanotubes as the carbon material, sufficient conductivity can be obtained even with a small amount, and the reduction in capacity per unit weight can be suppressed, as compared to the case where carbon nanotubes are used as the carbon material.

The carbon material (single-walled carbon nanotubes) described here may be a mixture of carbon nanotubes and single-walled carbon nanotubes. However, the proportion of single-walled carbon nanotubes is, for example, 70% by weight or more.

The type of metal material is not particularly limited. The number of types of metal material may be only one or two or more. Specifically, the metal material is, for example, tin, aluminum, germanium, copper, or nickel. The state of the metal material is not particularly limited, and is, for example, in the form of grains (powder). The average grain diameter (median diameter D50) of the metal material is not particularly limited, but in particular, it is preferably 30 nm to 3000 nm, more preferably 30 nm to 1000 nm, and still more preferably 50 nm to 500 nm.

The thickness and the coverage of the covering portion 202 can be set freely. The thickness of the covering portion 202 is preferably a thickness capable of protecting the central portion 201 without inhibiting the central portion 201 from occluding and releasing the electrode reactant. The coverage of the covering portion 202 is preferably a coverage capable of protecting the central portion 201 without inhibiting the central portion 201 from occluding and releasing the electrode reactant.

### (Ratios W1, W2, and W3)

Here, the ratio of the weight of each material contained in the covering portion 202 to the weight of the central portion 201 is not particularly limited. In particular, the ratio described above is preferably optimized so as to satisfy a predetermined condition.

Specifically, first, a ratio W1 of the weight of the salt compound contained in the covering portion 202 to the weight of the central portion 201 is preferably 0.1% by weight or more and less than 20% by weight. This is because the amount of coverage of the central portion 201 by the covering portion 202 is optimized, so that the negative electrode does not easily expand and contract at the time of discharge, and the electrolytic solution does not easily decompose. The ratio W1 is calculated by W1 (% by weight)=(weight of salt compound/weight of central portion 201)×100.

Second, in the case where the carbon material contains carbon nanotubes or the like, a ratio W2 of the weight of the carbon material contained in the covering portion 202 as the conductive substance to the weight of the central portion 201 is preferably 0.1% by weight or more and less than 15% by weight. This is because the electrical resistance of the negative electrode is reduced at the time of high load, and the plurality of first negative electrode active substances 200 can easily form the composite grain 200C. The ratio W2 is calculated by W2 (% by weight)=(weight of carbon material as conductive substance/weight of central portion 201)×100.

Third, in the case where the carbon material contains single-walled carbon nanotubes, the ratio W2 of the weight of the carbon material contained in the covering portion 202 as the conductive substance to the weight of the central portion 201 is preferably 0.001% by weight or more and less than 1% by weight. This is because the same advantage as in the case where the carbon material contains carbon nanotubes can be obtained.

Fourth, a ratio W3 of the weight of the metal material contained in the covering portion 202 as the conductive substance to the weight of the central portion 201 is preferably 0.1% by weight or more and less than 10% by weight. This is because the electrical resistance of the negative electrode is reduced at the time of high load, and the plurality of first negative electrode active substances 200 can easily form the composite grain 200C. The ratio W3 is calculated by W3 (% by weight)=(weight of metal material as conductive substance/weight of central portion 201)×100.

### (Configuration of Preferred First Negative Electrode Active Substance)

In particular, the plurality of first negative electrode active substances 200 preferably form a three-dimensional network structure described later. This is because the plurality of first negative electrode active substances 200 are firmly bonded to each other, and the conductivity is improved between the plurality of first negative electrode active substances 200. As a result, during charge and discharge, the negative electrode becomes more difficult to expand and contract, and the electrical resistance of the negative electrode becomes more difficult to increase.

In this case, in particular, by forming the above-mentioned three-dimensional network structure, the plurality of central portions 201 which are primary grains are strongly bonded to each other, and the conductivity is improved among the plurality of central portions 201 which are the primary grains. Therefore, the negative electrode becomes extremely difficult to expand and contract, and the electrical resistance of the negative electrode becomes extremely difficult to increase.

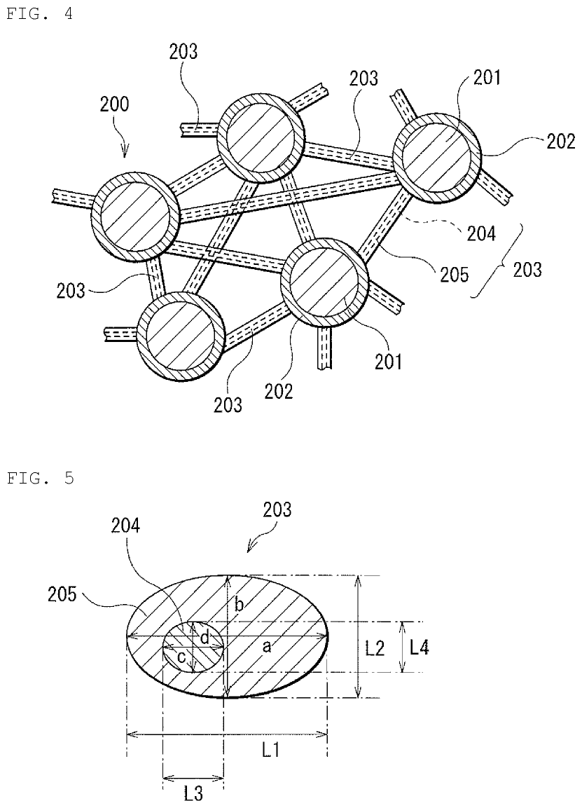

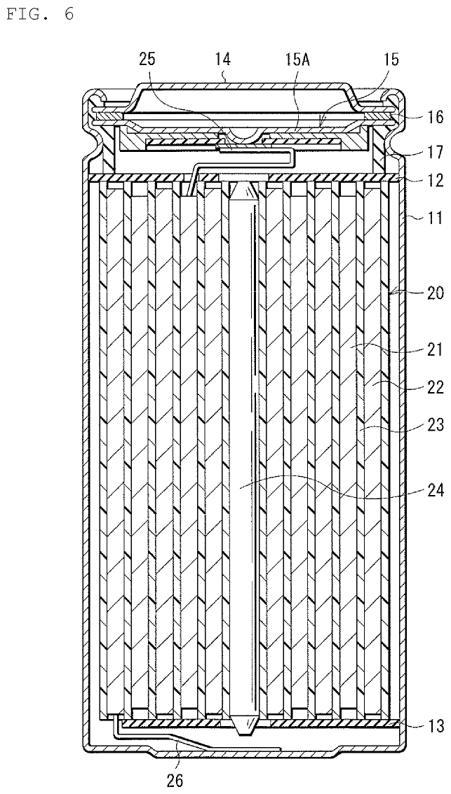

FIG. 4 schematically illustrates a plan configuration of a three-dimensional network structure formed by the plurality of first negative electrode active substances 200, and FIG. 5 enlarges a cross-sectional configuration of a connection portion 203 illustrated in FIG. 4.

For example, as described above, since the negative electrode active substance layer 2 contains the plurality of first negative electrode active substances 200, the plurality of first negative electrode active substances 200 include, for example, the plurality of central portions 201 and the plurality of covering portions 202. In this case, the plurality of first negative electrode active substances 200 preferably form the above-mentioned three-dimensional network structure, for example, as illustrated in FIG. 4. This is because the above-mentioned advantage can be obtained.

Here, the conductive substance contains, for example, any one or two or more types of fibrous carbon material as a carbon material. The “fibrous carbon material” is a generic term for carbon materials having a fibrous three-dimensional shape. The average fiber diameter of the fibrous carbon materials is not particularly limited, and is, for example, 0.1 nm to 50 nm. Specifically, the fibrous carbon material is, for example, the above-mentioned carbon nanotubes, carbon nanofibers, or single-walled carbon nanotubes.

In this case, for example, the plurality of first negative electrode active substances 200 are connected to each other via the plurality of connection portions 203 to form the three-dimensional network structure. The plurality of connection portions 203 extend, for example, between the plurality of first negative electrode active substances 200. The three-dimensional network structure may be formed of, for example, a part of the plurality of first negative electrode active substances 200, or may be formed of all of the plurality of first negative electrode active substances 200.

FIG. 4 illustrates only a part of the three-dimensional network structure (two-dimensional network structure) in order to simplify the illustration. Actually, in addition to the plurality of first negative electrode active substances 200 illustrated in FIG. 4, the plurality of first negative electrode active substances 200 are present on the front side of the drawing sheet of FIG. 4, and the plurality of first negative electrode active substances 200 exist on the depth side of the drawing sheet of FIG. 4. A series of the first negative electrode active substances 200 is connected to each another via the plurality of connection portions 203.

The number of other first negative electrode active substances 200 to which one first negative electrode active substance 200 is connected is not particularly limited, and may be, for example, only one or two or more.

The plurality of first negative electrode active substances 200 may form the composite grain 200C illustrated in FIG. 3 by, for example, forming the three-dimensional network structure using the plurality of connection portions 203 as described herein.

### (Connection Portion)

As described above, the plurality of connection portions 203 extend, for example, between the plurality of first negative electrode active substances 200. In this case, the two first negative electrode active substances 200 adjacent to each other are connected to each other via the connection portion 203. Therefore, the connection portion 203 extends from the surface of one first negative electrode active substance 200 to the surface of the other first negative electrode active substance 200 between the two first negative electrode active substances 200.

The connection portion 203 contains, for example, a fiber portion 204 and a protection portion 205 as illustrated in FIGS. 4 and 5.

### (Fiber Portion)

For example, the fiber portion 204 extends from the surface of one covering portion 202 to the surface of the other covering portion 202 between two covering portions 202 adjacent to each other. It is considered that the fiber portion 204 is formed mainly by deriving a part of the fibrous carbon material to the outside of the covering portion 202 so that the two covering portions 202 adjacent to each other are connected to each other in a process of forming the negative electrode active substance layer 2.

Further, the fiber portion 204 contains, for example, any one or two or more types of fibrous carbon material described above. This is because the fibrous carbon material is used to easily form the connection portion 203. The number of fibers of a fibrous carbon material contained in the fiber portion 204 is not particularly limited, and may be only one or two or more.

When the fibrous carbon material contains a tube-based material such as carbon nanotubes or single-walled carbon nanotubes, the average fiber diameter (average tube diameter) of the fibrous carbon material is not particularly limited, but as described above, is preferably 0.1 nm to 50 nm, and more preferably 0.1 nm to 10 nm. This is because a part of the fibrous carbon material is easily derived to the outside of the covering portion 202, and the fibrous carbon material is easily covered with the salt compound, so that the connection portion 203 is easily formed. In addition, since the connection portion 203 is easily formed even if the amount of the conductive substance (fibrous carbon material) is small, the reduction in capacity per unit weight is suppressed.

In addition, when the fibrous carbon material contains a fiber-based material such as carbon nanofibers, the average fiber diameter (average fiber diameter) of the fibrous carbon material is not particularly limited, but as described above, is preferably 0.1 nm to 50 nm, and more preferably 0.1 nm to 10 nm. This is because the same advantage as in the case where the fibrous carbon material is a tube-based material can be obtained.

That is, in the case where the conductive substance contains the fibrous carbon material as a carbon material, when the average tube diameter or the average fiber diameter of the plurality of first carbon fibers is within the above-mentioned proper range, the plurality of connection portions 203 can be easily formed between the plurality of negative electrode active substances 200. As a result, the plurality of first negative electrode active substances 200 can easily form the three-dimensional network structure using the plurality of connection portions 203.

### (Protection Portion)

The protective portion 205 is provided on a part or the entirety of the surface of the fiber portion 204, and therefore covers the outer peripheral surface of the fiber portion 204. That is, the protective portion 205 may cover only a part of the surface of the fiber portion 204, or may cover the entirety of the surface of the fiber portion 204. As a matter of course, when the protective portion 205 covers a part of the surface of the fiber portion 204, the plurality of protective portions 205 are provided on the surface of the fiber portion 204, that is, the plurality of protective portions 205 may cover the surface of the fiber portion 204.

In particular, the protective portion 205 is preferably provided only on the entirety of the surface of the fiber portion 204. This is because the entire fiber portion 204 is reinforced by the protective portion 205, so that the physical strength of the connection portion 203 is improved.

Further, protection portion 205 contains, for example, any one or two or more types of salt compound described above. For this reason, it is considered that the protective portion 205 is formed, as described above, mainly in such a manner that, when a part of the fibrous carbon material is derived to the outside of the covering portion 202, a part of the salt compound covers the fibrous carbon material, in the process of forming the negative electrode active substance layer 2

### (Ratio of Ratios W1/W2 and Cross-Sectional Area Ratio S1/S2)

Here, in the case where the plurality of first negative electrode active substances 200 form the three-dimensional network structure using the plurality of connection portions 203, the ratio (ratio of the ratios) W1/W2 of the ratio W1 to the ratio W2 described above and the ratio (cross-sectional area ratio) S2/S1 of the cross-sectional area S2 of the protective portion 205 to the cross-sectional area S1 of the connection portion 203 are not particularly limited. The “cross-sectional area S1 of the connection portion 203” is the cross-sectional area of the connection portion 203 in the extending direction of the connection portion 203, and the “cross-sectional area S2 of the protective portion 205” is the cross-sectional area of the protection portion 205 in the extending direction of the connection portion 203.

In particular, the ratio of the ratios W1/W2 preferably satisfies the relationship W1/W2≤200, and the cross-sectional area ratio S2/S1 preferably satisfies the relationship S2/S1≥0.5. This is because the plurality of first negative electrode active substances 200 can easily form the three-dimensional network structure using the plurality of connection portions 203, and the three-dimensional network structure can be easily maintained. As a result, the plurality of first negative electrode active substances 200 are more firmly bonded to each other, and the conductivity is further improved between the plurality of first negative electrode active substances 200.

The value of the ratio of the ratios W1/W2 is a value obtained by rounding off the value of the second decimal place. Further, the value of the cross-sectional area ratio S2/S1 is a value obtained by rounding off the value at the third decimal place.

Each of the cross-sectional areas S1 and S2 described here can be easily obtained based on the observation result of the cross section of the connection portion 203 as described below.

In the case of determining the cross-sectional area S1, first, the cross-section of the connection portion 203 including the fiber portion 204 and the protective portion 205 is observed as illustrated in FIG. 5 using any one or two or more types of microscope. The cross-sectional shape of the connection portion 203 is mainly an approximately elliptical shape defined by the major axis a and the minor axis b, and the cross-sectional shape of the fiber portion 204 is mainly an approximately elliptical shape defined by the major axis c and the minor axis d. Subsequently, based on the observation result of the cross section of the connection portion 203, each of the dimension L1 of the major axis a and the dimension L2 of the minor axis b are measured, and then based on the formula of diameter=(L1+L2)/2, the diameter of the connection portion 203 is calculated. The “diameter” calculated here is a diameter when it is assumed that the cross section of the connection portion 203 is a circle. Subsequently, the area (cross-sectional area) of the connection portion 203 is calculated based on the diameter of the connection portion 203 described above. Finally, the process of calculating the cross-sectional area of the connection portion 203 described above is repeated ten times, and then the average value of the ten cross-sectional areas is calculated to obtain the cross-sectional area S1 of the connection portion 203.

The type of microscope is not particularly limited, and is, for example, a transmission electron microscope (TEM). Specifically, for example, a transmission electron microscope JEM-ARM200F manufactured by JEOL Ltd. can be used.

In the case of obtaining the cross-sectional area S2, the same procedure as the procedure for obtaining the above-mentioned cross-sectional area S1 is used. In this case, first, as illustrated in FIG. 5, the cross section of the connection portion 203 is observed. Subsequently, the cross-sectional area of the connection portion 203 is calculated by the above-mentioned procedure. Subsequently, based on the observation result of the cross section of the fiber portion 204, each of the dimension L3 of the major axis c and the dimension L4 of the minor axis d are measured, and then based on the formula of diameter=(L3+L4)/2, the diameter of the fiber portion 204 is calculated. The “diameter” calculated here is a diameter when it is assumed that the cross section of the fiber portion 204 is a circle. Subsequently, the area (cross-sectional area) of the fiber portion 204 is calculated based on the diameter of the fiber portion 204 described above. Subsequently, the cross-sectional area of the protection portion 205 is calculated by subtracting the cross-sectional area of the fiber portion 204 from the cross-sectional area of the connection portion 203. Finally, the process of calculating the cross-sectional area of the protective portion 205 described above is repeated ten times, and then the average value of the ten cross-sectional areas is calculated to obtain the cross-sectional area S2 of the protective portion 205.

### (Second Negative Electrode Active Substance)

The second negative electrode active substance 300 contains any one or two or more types of carbon-based material. The “carbon-based material” is a generic term for materials containing carbon as a constituent element.

The second negative electrode active substance 300 contains the carbon-based material because the carbon-based material is difficult to expand and contract at the time of occlusion and release of the electrode reactant. As a result, the crystal structure of the carbon-based material is unlikely to change, and a high energy density can be stably obtained. In addition, since the carbon-based material also functions as a negative electrode conductive agent described later, the conductivity of the negative electrode active substance layer 2 is improved.

The type of carbon-based material is not particularly limited, and is, for example, graphitizable carbon, non-graphitizable carbon, and graphite. However, the spacing of the (002) plane relating to non-graphitizable carbon is preferably 0.37 nm or more, for example, and the spacing of the (002) plane relating to graphite is preferably 0.34 nm or less, for example.

More specifically, the carbon-based material is, for example, pyrolytic carbons, cokes, glassy carbon fibers, an organic polymer compound fired body, activated carbon, or carbon blacks. The cokes include, for example, pitch coke, needle coke, and petroleum coke. The organic polymer compound fired body is a fired (carbonized) product of a polymer compound, and the polymer compound is, for example, any one or two or more types of phenol resin and furan resin. Besides, the carbon-based material may be, for example, low crystalline carbon heat-treated at a temperature of about 1000° C. or lower, or amorphous carbon.

The shape of the second negative electrode active substance 300 is not particularly limited, and is, for example, fibrous, spherical (particulate), scaly, or the like. FIG. 2 illustrates, for example, the case where the shape of the second negative electrode active substance 300 is spherical. As a matter of course, the second negative electrode active substances 300 having two or more types of shape may be mixed.

When the shape of the second negative electrode active substance 300 is particulate, the average grain diameter (median diameter D50) of the second negative electrode active substance 300 is not particularly limited, and is, for example, about 5 μm to 40 μm.

### (Negative Electrode Binder)

The negative electrode binder contains any one or two or more types of polyvinylidene fluoride, polyimide, and aramid. This is because the first negative electrode active substances 200 and the second negative electrode active substances 300 are sufficiently bound.

In addition, as described later, a negative electrode is manufactured using a non-aqueous dispersion liquid containing the first negative electrode active substances 200, the second negative electrode active substances 300, and the negative electrode binder. In the non-aqueous dispersion liquid, each of the first negative electrode active substances 200 and the second negative electrode active substances 300 is dispersed, and the negative electrode binder is dissolved.

### (Other Materials)

The negative electrode active substance layer 2 may further contain any one or two or more types of other material.

Other materials are, for example, other negative electrode active substances capable of occluding and releasing an electrode reactant. The other negative electrode active substance contains any one or two or more types of metal-based material. The “metal-based material” is a generic term for materials containing any one or two or more types of metal element and metalloid element as a constituent element. This is because a high energy density can be obtained. However, the above-mentioned silicon-based material is excluded from the “metal-based material” described herein.

The metal-based material may be a single substance, an alloy, or a compound. In addition, the metal-based material may be a material including a phase of any one or two or more types of single substance, alloy, and compound described above at at least a part thereof. Note that, the meaning of “single substance” is as described above.

The alloy may contain two or more types of metal element as constituent elements, or may contain one or more types of metal element and one or more types of metalloid element as constituent elements. Further, the above-mentioned alloy may further contain one or more types of nonmetallic element as constituent elements. The structure of the alloy is, for example, a solid solution, a eutectic (eutectic mixture), an intermetallic compound, or a coexistence of two or more types thereof.

The metal element and the metalloid element contained in the metal-based material as constituent elements are, for example, any one or two or more types of metal element and metalloid element capable of forming an alloy with the electrode reactant. Specifically, there are given, for example, magnesium, boron, aluminum, gallium, indium, silicon, germanium, tin, lead, bismuth, cadmium, silver, zinc, hafnium, zirconium, yttrium, palladium, and platinum.

Among them, tin is preferred. This is because tin has an excellent ability to occlude and release the electrode reactant, so that a high energy density can be obtained.

Details of the alloy of tin and the compound of tin are, for example, as described above.

The alloy of tin contains, for example, any one or two or more types of nickel, copper, iron, cobalt, manganese, zinc, indium, silver, titanium, germanium, bismuth, antimony, chromium, and the like as a constituent element other than tin. The compound of tin contains, for example, any one or two or more types of carbon and oxygen as a constituent element other than tin. The compound of tin may contain, for example, any one or two or more types of a series of elements described for the alloy of tin as a constituent element other than tin.

The alloy of tin and the compound of tin are, for example, SnO_{w} (0<w≤2), SnSiO₃, LiSnO, or Mg₂Sn.

The material containing tin as a constituent element may be, for example, a material containing a second constituent element and a third constituent element together with tin which is a first constituent element (tin-containing material). The second constituent element is, for example, any one or two or more types of cobalt, iron, magnesium, titanium, vanadium (V), chromium, manganese, nickel, copper, zinc, gallium, zirconium, niobium, molybdenum (Mo), silver, indium, cesium (Cs), hafnium, tantalum (Ta), tungsten (W), bismuth, silicon, and the like. The third component element is, for example, any one or two or more types of boron, carbon, aluminum, phosphorus (P), and the like. This is because a high battery capacity and excellent cycle characteristics can be obtained.

Among them, the tin-containing material is preferably a material (tin-cobalt-carbon-containing material) containing tin, cobalt, and carbon as constituent elements. The composition of the tin-cobalt-carbon-containing material is, for example, as follows. The content of carbon is 9.9% by mass to 29.7% by mass. The content ratio of tin and cobalt (Co/(Sn+Co)) is 20% by mass to 70% by mass. This is because a high energy density can be obtained.

The tin-cobalt-carbon-containing material preferably includes a phase containing tin, cobalt, and carbon, which is low crystalline or amorphous. The phase is a phase (reactive phase) capable of reacting with the electrode reactant, and due to the presence of the reactive phase, excellent properties are obtained in the tin-cobalt-carbon-containing material. The half-width (diffraction angle 2θ) of the diffraction peak obtained by X-ray diffraction of the reaction phase is preferably 1° or more when the CuKα ray is used as the specific X-ray and the drawing speed is 1°/min. This is because the electrode reactant is likely to be occluded and released, and the reactivity to the electrolytic solution is reduced. In addition, the tin-cobalt-carbon-containing material may include other layers as well as a phase that is low crystalline or amorphous. The other layers are, for example, a phase containing a single substance of each constituent element or a phase containing a part of each constituent element.

Whether the diffraction peak obtained by X-ray diffraction corresponds to the reaction phase, that is, the phase capable of reacting with the electrode reactant can be easily determined through comparison of the X-ray diffraction chart before and after the electrochemical reaction with the electrode reactant. For example, if the position of the diffraction peak is changed before and after the electrochemical reaction with the electrode reactant, it can be determined that the diffraction peak corresponds to the reaction phase. In this case, for example, the diffraction peak of the phase that is low crystalline or amorphous is detected within the range of 28=20° to 50° The reaction phase contains, for example, the above-mentioned series of constituent elements, and is considered to be low crystalline or amorphous mainly due to the presence of carbon.

In the tin-cobalt-carbon-containing material, a part or the entirety of carbon which is a constituent element is bonded to a metal element or a metalloid element which is another constituent element. This is because aggregation and crystallization of tin and the like are suppressed. The bonding state of elements can be confirmed using, for example, X-ray photoelectron spectroscopy (XPS). In a commercially available apparatus, for example, Al-Kα rays and Mg-Kα rays are used as soft X-rays. When a part or the entirety of carbon is bonded to a metal element or a metalloid element or the like, the peak of the synthetic wave of 1s orbital (C1s) of carbon appears in a region lower than 284.5 eV. However, the peak of the 4f orbital (Au4f) of a gold atom is conditioned on energy calibration so as to be obtained at 84.0 eV. In this case, since the surface contamination carbon is usually present on the surface of the substance, the Cis peak of the surface contamination carbon is used as the energy standard (284.8 eV). In XPS measurement, the waveform of the Cis peak includes a peak attributable to surface contamination carbon and a peak attributable to carbon in the tin-cobalt-carbon-containing material. Therefore, for example, by analyzing the peaks using commercially available software, both the peaks are separated. In the analysis of the waveform, the position of the main peak present on the lowest binding energy side is used as the energy standard (284.8 eV).

The tin-cobalt-carbon-containing material may further contain, in addition to tin, cobalt, and carbon, for example, any one or two or more types of silicon, iron, nickel, chromium, indium, niobium, germanium, titanium, molybdenum, aluminum, phosphorus, gallium, bismuth, and the like as a constituent element.

Besides tin-cobalt-carbon-containing material, a material containing tin, cobalt, iron, and carbon as constituent elements (tin-cobalt-iron-carbon-containing material) is also preferable. The composition of the tin-cobalt-iron-carbon-containing material is optional.

The composition in the case of setting the content of iron to a small amount is, for example, as follows. The content of carbon is 9.9% by mass to 29.7% by mass. The content of iron is 0.3% by mass to 5.9% by mass. The content ratio of tin and cobalt (Co/(Sn+Co)) is 30% by mass to 70% by mass. This is because a high energy density can be obtained.

The composition in the case of setting the content of iron to a large amount is, for example, as follows. The content of carbon is 11.9% by mass to 29.7% by mass. The content ratio of tin, cobalt, and iron ((Co+Fe)/(Sn+Co+Fe)) is 26.4% by mass to 48.5% by mass. The content ratio of cobalt and iron (Co/(Co+Fe)) is 9.9% by mass to 79.5% by mass. This is because a high energy density can be obtained.

The physical properties (conditions such as half-width) of the tin-cobalt-iron-carbon-containing material are the same as the physical properties of the above-mentioned tin-cobalt-carbon-containing material.

Other negative electrode active substances are, for example, a metal oxide and a polymer compound. The metal oxide is, for example, iron oxide, ruthenium oxide, or molybdenum oxide. The polymer compound is, for example, polyacetylene, polyaniline, or polypyrrole.

Moreover, other materials are, for example, other negative electrode binders. Other negative electrode binders are, for example, synthetic rubber and a polymer compound. The synthetic rubber is, for example, fluorine-based rubber or ethylene propylene diene. The polymeric material is, for example, polyimide or polyacrylate. The details of the type and the like of the polyacrylate used as the negative electrode binder are, for example, the same as the details of the type and the like of the polyacrylate contained in the covering portion 202 described above.

Other materials are, for example, a negative electrode conductive agent. The negative electrode conductive agent contains, for example, any one or two or more types of carbon material and the like. The carbon material is, for example, graphite, carbon black, acetylene black, or ketjen black. Alternatively, the carbon material may be, for example, fibrous carbon containing carbon nanotubes. However, the negative electrode conductive agent may be a metal material, or a conductive polymer compound as long as the material has conductivity.

### <1-2. Manufacturing Method>

The negative electrode is manufactured, for example, by the procedure described below. In the following, since the forming materials of the series of components constituting the negative electrode have already been described in detail, the description of the forming materials is omitted as needed.

First, the central portion 201 containing a silicon-based material, a salt compound, a conductive substance, an aqueous solvent, and the like are mixed, and then the mixture is stirred. The stirring method and the stirring conditions are not particularly limited, and for example, a stirring device such as a stirrer may be used.

As a result, the central portion 201 and the conductive substance are dispersed in the aqueous solvent, and the salt compound is dissolved by the aqueous solvent, so that an aqueous dispersion liquid containing the central portion 201, the salt compound, and the conductive substance is prepared.

The type of aqueous solvent is not particularly limited, and is, for example, pure water. As the salt compound, for example, a non-dissolved material may be used or a dissolved material may be used. The dissolved material is, for example, a solution in which a salt compound is dissolved by pure water or the like, and is a so-called aqueous solution of a salt compound.

The aqueous dispersion liquid is subsequently dried with stirring. The stirring method is, for example, as described above. The stirring conditions and the drying conditions are not particularly limited.

In the aqueous dispersion liquid, the covering portion 202 containing the salt compound and the conductive substance is formed on the surface of the central portion 201, so that the first negative electrode active substance 200 is formed.

Subsequently, the first negative electrode active substances 200, the second negative electrode active substances 300 containing a carbon-based material, a negative electrode binder containing polyvinylidene fluoride and the like, a non-aqueous solvent, and, if necessary, a negative electrode conductive agent are mixed, and the mixture is then stirred. The stirring method and the stirring conditions are not particularly limited, and for example, a stirring device such as a mixer may be used.

The type of non-aqueous solvent is not particularly limited as long as it is any one or two or more types of material capable of dispersing each of the first negative electrode active substances 200 and the second negative electrode active substances 300 and dissolving the negative electrode binder. The non-aqueous solvent is, for example, an organic solvent such as N-methyl-2-pyrrolidone.

As a result, the negative electrode binder is dissolved by the non-aqueous solvent, so that the non-aqueous dispersion liquid containing the first negative electrode active substances 200, the second negative electrode active substances 300, and the negative electrode binder is prepared. The state of the non-aqueous dispersion liquid is not particularly limited, and is, for example, in the form of paste. The non-aqueous dispersion liquid in the form of paste is so-called slurry.

Finally, the non-aqueous dispersion liquid is used to make the negative electrode. In this case, for example, the non-aqueous dispersion liquid is coated on both sides of the negative electrode current collector 1, and then the non-aqueous dispersion liquid is dried. As a result, the negative electrode active substance layer 2 containing the first negative electrode active substances 200, the second negative electrode active substances 300, and the negative electrode binder is formed, and thus the negative electrode is completed.

After that, the negative electrode active substance layer 2 may be compression-molded using a roll press machine or the like. In this case, the negative electrode active substance layer 2 may be heated or compression molding may be repeated multiple times. The compression conditions and the heating conditions are not particularly limited.

In addition, in the above-mentioned manufacturing method for an negative electrode, another method may be used so as to obtain the first negative electrode active substance 200. In this case, two or more methods may be used in combination.

Specifically, for example, a spray dry method may be used. In the case of using the spray drying method, for example, the aqueous dispersion liquid is sprayed using a spray drying apparatus, and then the sprayed object is dried. As a result, the covering portion 202 is formed on the surface of the central portion 201, so that the first negative electrode active substance 200 can be obtained.

In particular, by using the spray drying method, while forming the plurality of first negative electrode active substances 200, it is possible to form the composite grain 200C that is the aggregate of the plurality of first negative electrode active substances 200. In this case, for example, by using a fibrous carbon material as the conductive substance (carbon material), the three-dimensional network structure illustrated in FIG. 4 is formed, so that the composite grain 200C is formed.

Further, for example, a pulverization method may be used. In the case of using a pulverization method, for example, the aqueous dispersion liquid is dried, and then the dried object is pulverized using a pulverizer. As a result, the covering portion 202 is formed on the surface of the central portion 201, so that the first negative electrode active substance 200 can be obtained. The type of pulverizer is not particularly limited, and is, for example, a planetary ball mill.

### <1-3. Action and Effect>

According to the negative electrode, the first negative electrode active substances 200, the second negative electrode active substances 300, and the negative electrode binder are included. The first negative electrode active substance 200 includes the central portion 201 including the silicon-based material, and the covering portion 202 containing the salt compound and the conductive substance. The second negative electrode active substance 300 contains the carbon-based material. The negative electrode binder contains polyvinylidene fluoride and the like.

In this case, as described above, the binding properties of the first negative electrode active substance 200 and the second negative electrode active substance 300 are secured, the central portion 201 easily occludes and releases the electrode reactant while securing the conductivity of the covering portion 202, and the decomposition reaction of the electrolytic solution caused by the reactivity of the central portion 201 is suppressed. Therefore, even if charge and discharge are repeated, the secondary battery is less likely to swell and the discharge capacity is less likely to be reduced. Thus, the battery characteristics of the secondary battery using the negative electrode can be improved.

In particular, if the plurality of first negative electrode active substances 200 form the composite grain 200C, the electrical resistance of the composite grain 200C is reduced, and each central portion 201 contained in the composite grain 200C easily occludes and releases the electrode reactant, so that higher effects can be obtained.

In this case, if the specific surface area of the composite grain 200C is 0.1 m²/g to 10 m²/g, the loss of discharge capacity is suppressed, and the increase of the electrical resistance of the negative electrode at the time of high load is suppressed, so that higher effects can be obtained.

In addition, if polyacrylate contains lithium polyacrylate and the like, and carboxymethyl cellulose salt contains carboxymethyl cellulose lithium and the like, while ensuring the occlusion and the release of the electrode reactant in the central portion 201, the decomposition reaction of the electrolytic solution caused by the reactivity of the central portion 201 is sufficiently suppressed by the covering portion 202, so that higher effects can be obtained.

If the ratio W1 is 0.1% by weight or more and less than 20% by weight, the negative electrode does not easily expand and contract at the time of discharge, and the electrolytic solution does not easily decompose, so that higher effects can be obtained.

In addition, if the carbon material contains carbon nanotubes and the like, the conductivity of the covering portion 202 is sufficiently improved, so that higher effects can be obtained. In this case, if the average tube diameter of the carbon nanotubes is 1 nm to 300 nm, the conductivity is further improved, so that higher effects can be obtained. In addition, if the ratio W2 is 0.1% by weight or more and less than 15% by weight, the increase in the electrical resistance is suppressed at the time high load, so that higher effects can be obtained.

In addition, if the carbon material contains single-walled carbon nanotubes, the conductivity of the covering portion 202 is sufficiently improved, so that higher effects can be obtained. In this case, if the average tube diameter of the single-walled carbon nanotubes is 0.1 nm to 5 nm, the conductivity is further improved, so that higher effects can be obtained. In addition, if the ratio W2 is 0.001% by weight or more and less than 1% by weight, the increase in the electrical resistance is suppressed at the time high load, so that higher effects can be obtained.

In addition, if the carbon material contains fibrous carbon material, the average fiber diameter of the fibrous carbon material is 0.1 nm to 50 nm, and the plurality of first negative electrode active substances 200 are connected to each other using the plurality of connecting portions 203 each including the fiber portion 204 and the protective portion 205 to form the three-dimensional network structure, the negative electrode becomes more difficult to expand and contract, and the electrical resistance of the negative electrode becomes more difficult to increase, so that higher effects can be obtained.

In this case, if the fibrous carbon material contains carbon nanotubes and the like having the above-mentioned average fiber diameter, the connection portion 203 is easily formed, and thus, the reduction in capacity per unit weight is suppressed, so that higher effects can be obtained. Further, if the ratio of the ratios W1/W2 satisfies W1/W2≤200 and the cross-sectional area ratio S2/S1 satisfies S2/S1≥0.5, the above three-dimensional network structure is easily formed, and is easily maintained, so that higher effects can be obtained.

In addition, if the metal material contains tin and the like, the conductivity of the covering portion 202 is sufficiently improved, so that higher effects can be obtained. In this case, if the ratio W3 is 0.1% by weight to 10% by weight, the increase in the electrical resistance is suppressed at the time high load, so that higher effects can be obtained.

### <2. Secondary Battery>

Next, the secondary battery using the above-mentioned negative electrode of the present technology will be described.

### <2-1. Lithium Ion Secondary Battery (Cylindrical Type)>

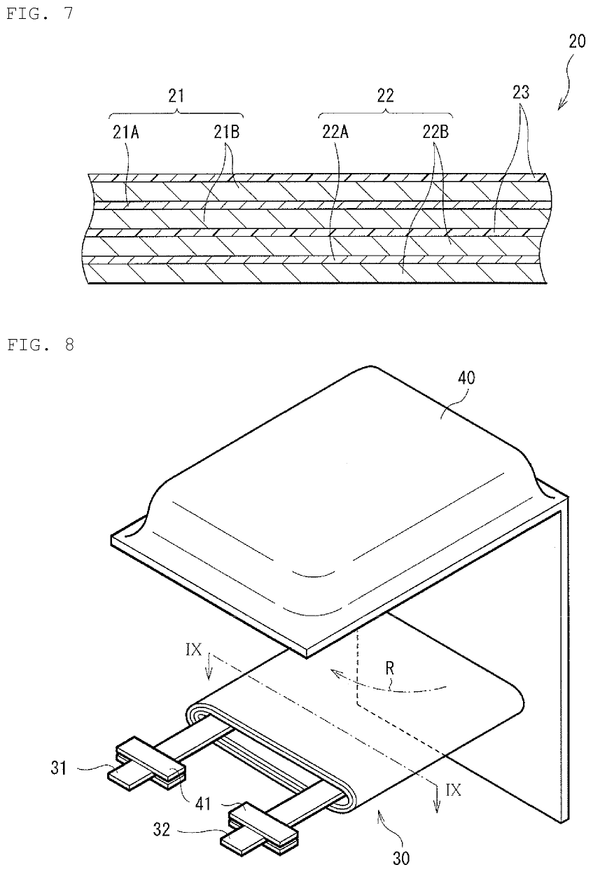

FIG. 6 illustrates a cross-sectional configuration of the secondary battery, and FIG. 7 enlarges a part of a cross-sectional configuration of a wound electrode body 20 illustrated in FIG. 6.

The secondary battery described here is, for example, a lithium ion secondary battery in which the capacity of the negative electrode 22 is obtained by occlusion and release of lithium which is an electrode reactant.

### [Overall Configuration]

The secondary battery has a cylindrical battery structure. In the secondary battery, for example, as illustrated in FIG. 6, a pair of insulating plates 12 and 13, and the wound electrode body 20 which is a battery element are housed inside a hollow cylindrical battery can 11. In the wound electrode body 20, for example, a positive electrode 21 and a negative electrode 22 which are laminated via a separator 23 are wound. The wound electrode body 20 is impregnated with, for example, an electrolytic solution which is a liquid electrolyte.

The battery can 11 has, for example, a hollow structure in which one end is closed and the other end is open, and contains, for example, any one or two or more types of iron, aluminum, and their alloys. Nickel or the like may be plated on the surface of the battery can 11. The pair of insulating plates 12 and 13 sandwich the wound electrode body 20 and extend perpendicularly to the winding peripheral surface of the wound electrode body 20.

At the open end of the battery can 11, a battery cover 14, a safety valve mechanism 15, and a thermal resistance element (PTC element) 16 are crimped with a gasket 17. As a result, the battery can 11 is sealed. The battery cover 14 contains, for example, the same material as the battery can 11. Each of the safety valve mechanism 15 and the thermal resistance element 16 is provided on the inner side with respect to the battery cover 14, and the safety valve mechanism 15 is electrically connected to the battery cover 14 through the thermal resistance element 16. In the safety valve mechanism 15, a disc plate 15A is reversed when the internal pressure becomes equal to or higher than a certain level due to internal short circuit or external heating. As a result, the electrical connection between the battery cover 14 and the wound electrode body 20 is cut off. In order to prevent abnormal heat generation caused by a large current, the electrical resistance of the thermal resistance element 16 increases with the temperature rise. The gasket 17 contains, for example, an insulating material, and the surface of the gasket 17 may be coated with asphalt or the like.

For example, a center pin 24 is inserted in a space formed at the winding center of the wound electrode body 20. However, the center pin 24 may not be inserted. A positive electrode lead 25 is connected to the positive electrode 21, and a negative electrode lead 26 is connected to the negative electrode 22. The positive electrode lead 25 contains, for example, a conductive material such as aluminum. The positive electrode lead 25 is connected to, for example, the safety valve mechanism 15 and electrically conducted to the battery cover 14. The negative electrode lead 26 contains, for example, a conductive material such as nickel. The negative electrode lead 26 is connected to, for example, the battery can 11 and electrically conducted to the battery can 11.

### (Positive Electrode)

For example, as illustrated in FIG. 7, the positive electrode 21 includes a positive electrode current collector 21A and positive electrode active substance layers 21B provided on the positive electrode current collector 21A.

The positive electrode active substance layer 21B may be provided only on one side of the positive electrode current collector 21A or may be provided on both sides of the positive electrode current collector 21A. FIG. 7 illustrates, for example, the case where the positive electrode active substance layers 21B are provided on both sides of the positive electrode current collector 21A.

The positive electrode current collector 21A contains, for example, any one or two or more types of conductive material. The type of conductive material is not particularly limited, is a metal material such as aluminum, nickel, and stainless steel, and it may be an alloy containing any two or more types of metal material. The positive electrode current collector 21A may be a single layer or a multilayer.

The positive electrode active substance layer 21B contains, as a positive electrode active substance, any one or two or more types of positive electrode material capable of occluding and extracting lithium. However, the positive electrode active substance layer 21B may further contain any one or two or more types of other material such as a positive electrode binder and a positive electrode conductive agent. The positive electrode active substance layer 21B may be a single layer or a multilayer.

The positive electrode material is preferably any one or two or more types of lithium-containing compound. The type of lithium-containing compound is not particularly limited, but in particular, it is preferably a lithium-containing composite oxide or a lithium-containing phosphate compound. This is because a high energy density can be obtained.

The “lithium-containing composite oxide” is an oxide containing lithium and one or two or more types of other element as a constituent element, and the “other elements” are an element other than lithium. The lithium-containing oxide has, for example, a crystal structure of any one or two or more types of layered rock salt type and spinel type.

The “lithium-containing phosphate compound” is a phosphate compound containing lithium and one or two or more types of other element as a constituent element. The lithium-containing phosphate compound has, for example, a crystal structure of any one or two or more types of olivine type and the like.

The type of other element is not particularly limited as long as it is any one or two or more types of arbitrary element (except lithium). In particular, the other element is preferably any one or two or more types of element belonging to Groups 2 to 15 in the long period periodic table. More specifically, the other element is more preferably any one or two or more types of metal element of nickel, cobalt, manganese, and iron. This is because a high voltage can be obtained.

The lithium-containing composite oxide having a crystal structure of the layered rock salt type is, for example, a compound represented by each of the following formulas (1) to (3).

LiₐMn_{(1-b-c)}Ni_{b}M1_{c}O_{(2-d)}F_{d} (1)

(M1 is at least one type of cobalt, magnesium, aluminum, boron, titanium, vanadium, chromium, iron, copper, zinc, zirconium, molybdenum, tin, calcium, strontium, and tungsten; a to e satisfy 0.8≤a≤1.2, 0<b<0.5, 0≤c≤0.5, (b+c)<1, −0.1≤d≤0.2, and 0≤e≤0.1; however, the composition of lithium varies depending on the charge and discharge state, and a is a value in a completely discharged state.)

LiₐNi_{(1-b)}M2_{b}O_{(2-c)}F_{d} (2)

(M2 is at least one type of cobalt, manganese, magnesium, aluminum, boron, titanium, vanadium, chromium, iron, copper, zinc, molybdenum, tin, calcium, strontium, and tungsten; a to d satisfy 0.8≤a≤1.2, 0.005≤b≤0.5, −0.1≤c≤0.2, and 0≤d≤0.1; however, the composition of lithium varies depending on the charge and discharge state, and a is a value in a completely discharged state.)

LiₐCo_{(1-b)}M3_{b}O_{(2-c)}F_{d} (3)

(M3 is at least one type of nickel, manganese, magnesium, aluminum, boron, titanium, vanadium, chromium, iron, copper, zinc, molybdenum, tin, calcium, strontium, and tungsten; a to d satisfy 0.8≤a≤1.2, 0≤b<0.5, −0.1≤c≤0.2, and 0≤d≤0.1; however, the composition of lithium varies depending on the charge and discharge state, and a is a value in a completely discharged state.)

The lithium-containing composite oxide having a crystal structure of the layered rock salt type is, for example, LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, or Li_{1.15} (Mn_{0.65}Ni_{0.22}Co_{0.13}) O₂.

When the lithium-containing composite oxide having a crystal structure of the layered rock salt type contains nickel, cobalt, manganese, and aluminum as constituent elements, the atomic ratio of nickel is preferably 50 atomic % or more. This is because a high energy density can be obtained.

The lithium-containing composite oxide having a crystal structure of the spinel type is, for example, a compound represented by the following formula (4).

LiₐMn_{(2-b)}M4_{b}O_{c}F_{d} (4)

(M4 is at least one type of cobalt, nickel, magnesium, aluminum, boron, titanium, vanadium, chromium, iron, copper, zinc, molybdenum, tin, calcium, strontium, and tungsten; a to d satisfy 0.9≤a≤1.1, 0≤b≤0.6, 3.7≤c≤4.1, and 0≤d≤0.1; however, the composition of lithium varies depending on the charge and discharge state, and a is a value in a completely discharged state.)

The lithium-containing composite oxide having a crystal structure of the spinel type is, for example, LiMn₂O₄ or the like.

The lithium-containing phosphate compound having a crystal structure of the olivine type is, for example, a compound represented by the following formula (5).

LiₐM5PO₄ (5)

(M5 is at least one type of cobalt, manganese, iron, nickel, magnesium, aluminum, boron, titanium, vanadium, niobium, copper, zinc, molybdenum, calcium, strontium, tungsten, and zirconium; a satisfies 0.9≤a≤1.1; however, the composition of lithium varies depending on the charge and discharge state, and a is a value in a completely discharged state.)

The lithium-containing phosphate compound having a crystal structure of the olivine type is, for example, LiFePO₄, LiMnPO₄, LiFe_{0.5}Mn_{0.5}PO₄, LiFe_{0.3}Mn_{0.7}PO₄, or the like.

In addition, the lithium-containing composite oxide may be a compound represented by the following formula (6).

(Li₂MnO₂)ₓ(LiMnO₂)₁₋ₓ (6)

(x satisfies 0≤x≤1; however, the composition of lithium varies depending on the charge and discharge state, and x is a value in a completely discharged state.)

Besides, the positive electrode material may be, for example, an oxide, a disulfide, a chalcogenide, or a conductive polymer. The oxide is, for example, titanium oxide, vanadium oxide, or manganese dioxide. The disulfide is, for example, titanium disulfide or molybdenum sulfide. The chalcogenide is, for example, niobium selenide. The conductive polymer is, for example, sulfur, polyaniline, or polythiophene.

However, the positive electrode material is not limited to the above-mentioned materials, and may be other materials.

The details of the positive electrode binder are, for example, the same as the details of the negative electrode binder described above and other negative electrode binders. Further, details of the positive electrode conductive agent are, for example, the same as the details of the negative electrode conductive agent described above.

### (Negative Electrode)

The negative electrode 22 has the same configuration as the above-mentioned negative electrode of the present technology.

Specifically, for example, as illustrated in FIG. 7, the negative electrode 22 includes a negative electrode current collector 22A and negative electrode active substance layers 22B provided on the negative electrode current collector 22A. The configuration of the negative electrode current collector 22A is the same as the configuration of the negative electrode current collector 1, and the configuration of the negative electrode active substance layer 22B is the same as the configuration of the negative electrode active substance layer 2.

### (Separator)

The separator 23 is arranged between the positive electrode 21 and the negative electrode 22. As a result, the separator 23 allows lithium ions to pass while preventing the occurrence of short circuit due to the contact between the positive electrode 21 and the negative electrode 22.

The separator 23 contains, for example, any one or two or more types of porous film such as synthetic resin and ceramic, and may be a laminated film of two or more types of porous film. The synthetic resin is, for example, polytetrafluoroethylene, polypropylene, or polyethylene.

The separator 23 may include, for example, the above-mentioned porous film (base material layer), and a polymer compound layer provided on the base material layer. This is because the close contact property of the separator 23 to each of the positive electrode 21 and the negative electrode 22 is improved, so that the wound electrode body 20 is hardly distorted. As a result, the decomposition reaction of the electrolytic solution is suppressed, and the leakage of the electrolytic solution impregnated in the base material layer is also suppressed. Therefore, the electrical resistance is less likely to increase even if charge and discharge are repeated, and the secondary battery is less likely to swell.

The polymer compound layer may be provided only on one side of the base material layer or may be provided on both sides of the base material layer. The polymer compound layer contains, for example, any one or two or more types of polymer material such as polyvinylidene fluoride. This is because polyvinylidene fluoride is excellent in physical strength and electrochemically stable. In the case of forming the polymer compound layer, for example, a solution in which a polymer material is dissolved with an organic solvent or the like is coated on a substrate layer, and then the substrate layer is dried. In addition, the base material layer is immersed in the solution, and then the base material layer may be dried.

### (Electrolytic Solution)

The electrolyte contains, for example, a solvent and an electrolyte salt. The number of types of solvent may be only one or two or more. The number of types of electrolyte salt may be one or two or more. The electrolytic solution may further contain any one or two or more types of various material such as additives.

The solvent contains a non-aqueous solvent such as an organic solvent. The electrolytic solution containing a non-aqueous solvent is a so-called non-aqueous electrolytic solution.

The solvent is, for example, cyclic carbonate, chain carbonate, lactone, chain carbonate ester, or nitrile (mononitrile). This is because excellent battery capacity, cycle characteristics, and storage characteristics can be obtained.

The cyclic carbonate is, for example, ethylene carbonate, propylene carbonate, or butylene carbonate. The chain carbonate is, for example, dimethyl carbonate, diethyl carbonate, ethyl methyl carbonate, or methyl propyl carbonate. The lactone is, for example, γ-butyrolactone or γ-valerolactone. The chain carbonate ester is, for example, methyl acetate, ethyl acetate, methyl propionate, ethyl propionate, propyl propionate, methyl butyrate, methyl isobutyrate, methyl trimethylacetate, methyl trimethylacetate, or the like. The nitrile is, for example, acetonitrile, methoxyacetonitrile, or 3-methoxypropionitrile.

Besides, the solvent is, for example, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N, N-dimethylformamide, N-methylpyrrolidinone, N-methyloxazolidinone, N, N′-dimethylimidazolidinone, nitromethane, nitroethane, sulfolane, trimethyl phosphate, or dimethyl sulfoxide. This is because the same advantage can be obtained.

In particular, any one or two or more types of carbonate such as ethylene carbonate, propylene carbonate, dimethyl carbonate, diethyl carbonate, and ethyl methyl carbonate are preferable. This is because more excellent battery capacity, cycle characteristics, and storage characteristics can be obtained.

In this case, a combination of a high viscosity (high dielectric constant) solvent (for example, relative permittivity ε≥30) which is a cyclic carbonate such as ethylene carbonate or propylene carbonate, and a low viscosity solvent (for example, viscosity≤1 mPa·s) which is chain carbonate such as dimethyl carbonate, ethyl methyl carbonate, or diethyl carbonate is more preferable. This is because the dissociative nature of the electrolyte salt and the mobility of the ions are improved.

Further, the solvent may be unsaturated cyclic carbonate, halogenated carbonate, sulfonic acid ester, acid anhydride, dinitrile compound, diisocyanate compound, phosphate ester, or the like. This is because the chemical stability of the electrolytic solution is improved.

The unsaturated cyclic carbonate is a cyclic carbonate having one or two or more unsaturated bonds (carbon-carbon double bonds). The unsaturated cyclic carbonate is, for example, vinylene carbonate (1,3-dioxole-2-one), vinylethylene carbonate (4-vinyl-1,3-dioxolan-2-one), methyleneethylene carbonate (4-methylene-1,3-dioxolan-2-one), or the like. The content of the unsaturated cyclic carbonate in the solvent is not particularly limited, and is, for example, 0.01% by weight to 10% by weight.

The halogenated carbonate is a cyclic or chain carbonate containing one or two or more halogens as a constituent element. The type of halogen is not particularly limited, and is, for example, any one or two or more types of fluorine (F), chlorine (Cl), bromine (Br), and iodine (I). The cyclic halogenated carbonate is, for example, 4-fluoro-1,3-dioxolan-2-one or 4,5-difluoro-1,3-dioxolan-2-one. The chain halogenated carbonate is, for example, fluoromethyl methyl carbonate, bis(fluoromethyl) carbonate, or difluoromethyl methyl carbonate. The content of the halogenated carbonate in the solvent is not particularly limited, and is, for example, 0.01% by weight to 50% by weight.

The sulfonic acid ester is, for example, monosulfonic acid ester or disulfonic acid ester. The monosulfonic acid ester may be cyclic monosulfonic acid ester or chain monosulfonic acid ester. The cyclic monosulfonic acid ester is, for example, sultone such as 1,3-propane sultone or 1,3-propene sultone. The chain monosulfonic acid ester is, for example, a compound in which a cyclic monosulfonic acid ester is cleaved halfway. The disulfonic acid ester may be cyclic disulfonic acid ester or chain disulfonic acid ester. The content of the sulfonic acid ester in the solvent is not particularly limited, and is, for example, 0.5% by weight to 5% by weight.

The acid anhydride is, for example, carbonate anhydride, disulfonic acid anhydride, or carboxylic acid sulfonic acid anhydride. The carboxylic anhydride is, for example, succinic anhydride, glutaric anhydride, or maleic anhydride. The disulfonic acid anhydride is, for example, anhydrous ethanedisulfonic acid or anhydrous propanedisulfonic acid. The carboxylic acid sulfonic acid anhydride is, for example, sulfobenzoic anhydride, sulfopropionic anhydride, or sulfobutyric anhydride. The content of the acid anhydride in the solvent is not particularly limited, and is, for example, 0.5% by weight to 5% by weight.

The dinitrile compound is, for example, a compound represented by NC—R1-CN (R1 is any of an alkylene group and an arylene group). The dinitrile compound is, for example, succinonitrile (NC—C₂H₄—CN), glutaronitrile (NC—C₃H₆—CN), adiponitrile (NC—C₄H₈—CN), or phthalonitrile (NC—C₆H₅—CN) The content of the dinitrile compound in the solvent is not particularly limited, and is, for example, 0.5% by weight to 5% by weight.

The diisocyanate compound is, for example, a compound represented by OCN—R2-NCO (R2 is any of an alkylene group and an arylene group). The diisocyanate compound is, for example, OCN—C₆H₁₂—NCO. The content of the diisocyanate compound in the solvent is not particularly limited, and is, for example, 0.5% by weight to 5% by weight.

Specific examples of phosphate ester include trimethyl phosphate, triethyl phosphate, and triallyl phosphate. The content of the phosphate ester in the solvent is not particularly limited, and is, for example, 0.5% by weight to 5% by weight.

The electrolyte salt contains, for example, any one or two or more types of lithium salt. However, the electrolyte salt may contain, for example, salt other than lithium salt. The salt other than lithium is, for example, salt of light metal other than lithium.

The lithium salt is, for example, lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB (C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), or lithium bromide (LiBr). This is because excellent battery capacity, cycle characteristics, and storage characteristics can be obtained.

In particular, any one or two or more types of lithium hexafluorophosphate, lithium tetrafluoroborate, lithium perchlorate, and lithium hexafluoroarsenate are preferable, and lithium hexafluorophosphate is more preferable. This is because a higher effect can be obtained due to the reduction in the internal resistance.

The content of the electrolyte salt is not particularly limited, but in particular, it is preferably 0.3 mol/kg to 3.0 mol/kg with respect to the solvent. This is because high ion conductivity can be obtained.

### [Operation]

The secondary battery operates, for example, as follows.

At the time of charging, lithium ions are released from the positive electrode 21, and the lithium ions are occluded in the negative electrode 22 through the electrolytic solution. On the other hand, at the time of discharge, lithium ions are released from the negative electrode 22, and the lithium ions are occluded in the positive electrode 21 through the electrolytic solution.

### [Manufacturing Method]

The secondary battery is manufactured, for example, by the procedure described below.

In the case of producing the positive electrode 21, first, a positive electrode active substance, a positive electrode binder, a positive electrode conductive agent, and the like are mixed to form a positive electrode mixture. Subsequently, the positive electrode mixture is added to an organic solvent or the like, and then the organic solvent is stirred to form paste-like positive electrode mixture slurry. Finally, the positive electrode mixture slurry is coated on both sides of the positive electrode current collector 21A, and then the positive electrode mixture slurry is dried to form the positive electrode active substance layer 21B. After that, the positive electrode active substance layer 21B may be compression-molded using a roll press machine or the like. In this case, the positive electrode active substance layer 21B may be heated or compression molding may be repeated multiple times.

In the case of producing the negative electrode 22, the negative electrode active substance layer 22B is formed on both sides of the negative electrode current collector 22A by the same procedure as the method of manufacturing the negative electrode of the present technology described above.

In the case of assembling the secondary battery, the positive electrode lead 25 is connected to the positive electrode current collector 21A using a welding method or the like, and the negative electrode lead 26 is connected to the negative electrode current collector 22A using a welding method or the like. Subsequently, the positive electrode 21 and the negative electrode 22 laminated via the separator 23 are wound to form the wound electrode body 20. Subsequently, the center pin 24 is inserted in the space formed at the winding center of the wound electrode body 20.

Subsequently, the wound electrode body 20 is housed inside the battery can 11 while the wound electrode body 20 is sandwiched by the pair of insulating plates 12 and 13. In this case, the positive electrode lead 25 is connected to the safety valve mechanism 15 using a welding method or the like, and the negative electrode lead 26 is connected to the battery can 11 using a welding method or the like. Subsequently, the electrolytic solution is injected into the inside of the battery can 11 to impregnate the wound electrode body 20 with the electrolytic solution. Finally, the battery cover 14, the safety valve mechanism 15, and the thermal resistance element 16 are crimped at the opening end of the battery can 11 with the gasket 17. As a result, a cylindrical secondary battery is completed.

### [Action and Effect]

According to this secondary battery, since the negative electrode 22 has the same configuration as that of the above-mentioned negative electrode of the present technology, even if charge and discharge are repeated, the secondary battery is less likely to swell and the discharge capacity is less likely to be reduced. Therefore, the battery characteristics of the secondary battery can be improved.

The other actions and effects are similar to the actions and effects of the negative electrode of the present technology.

### <2-2. Lithium Ion Secondary Battery (Laminated Film Type)>

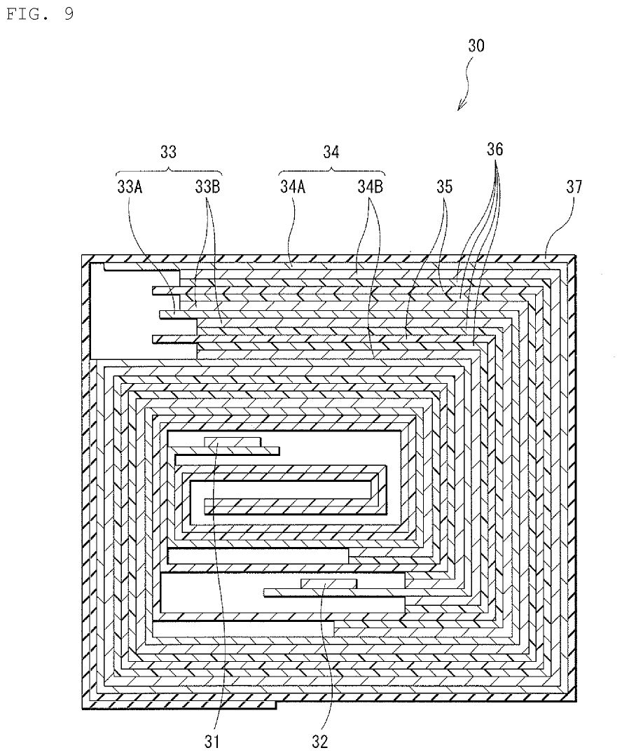

FIG. 8 illustrates a perspective configuration of another secondary battery, and FIG. 9 illustrates a cross-sectional configuration of a wound electrode body 30 taken along the line IX-IX illustrated in FIG. 8. In addition, in FIG. 8, a state in which the wound electrode body 30 and an exterior member 40 are separated from each other is illustrated.

In the following description, the components of the cylindrical secondary battery described above will be referred to as needed.

### [Overall Configuration]

The secondary battery is a lithium ion secondary battery having a battery structure of laminated film type. In the secondary battery, for example, as illustrated in FIG. 8, the wound electrode body 30 which is a battery element is housed inside the film-like exterior member 40. In the wound electrode body 30, for example, a positive electrode 33 and a negative electrode 34 laminated via a separator 35 and a electrolyte layer 36 are wound. A positive electrode lead 31 is connected to the positive electrode 33, and a negative electrode lead 32 is connected to the negative electrode 34. The outermost periphery of the wound electrode body 30 is protected by a protective tape 37.

Each of the positive electrode lead 31 and the negative electrode lead 32 is, for example, derived from the inside to the outside of the exterior member 40 in the same direction. The positive electrode lead 31 contains, for example, any one or two or more types of conductive material such as aluminum. The negative electrode lead 32 contains, for example, any one or two or more types of conductive material such as copper, nickel, and stainless steel. These conductive material is, for example, sheet-like or mesh-like.

The exterior member 40 is, for example, a single sheet of film that can be folded in the direction of the arrow R illustrated in FIG. 8, and a recess for storing the wound electrode body 30 is provided at a part of the exterior member 40. The exterior member 40 is, for example, a laminated film in which a fusion layer, a metal layer, and a surface protective layer are laminated in this order. In the manufacturing process of the secondary battery, the exterior member 40 is folded so that fusion layers are opposed to each other via the wound electrode body 30, and the outer peripheral edge portions of the fusion layers are fused. However, the exterior member 40 may be two laminated films connected to each other through an adhesive or the like. The fusion layer contains, for example, any one or two or more types of film such as polyethylene and polypropylene. The metal layer contains, for example, any one or two or more types of metal foil such as an aluminum foil. The surface protective layer contains, for example, any one or two or more types of film such as nylon and polyethylene terephthalate.

In particular, the exterior member 40 is preferably an aluminum laminated film in which a polyethylene film, an aluminum foil, and a nylon film are laminated in this order. However, the exterior member 40 may be a laminated film having another laminated structure, a polymer film such as polypropylene, or a metal film.

For example, a close contact film 41 is inserted between the exterior member 40 and the positive electrode lead 31 in order to prevent outside air from entering. Further, for example, the above-mentioned close contact film 41 is inserted between the exterior member 40 and the negative electrode lead 32. The close contact film 41 contains any one or two or more types of material having a close contact property to both of the positive electrode lead 31 and the negative electrode lead 32. The material having close contact property is, for example, polyolefin resin, and more specifically, polyethylene, polypropylene, modified polyethylene, modified polypropylene, or the like.

### (Positive Electrode, Negative Electrode, and Separator)

For example, as illustrated in FIG. 9, the positive electrode 33 includes a positive electrode current collector 33A and a positive electrode active substance layer 33B. The negative electrode 34 has the same configuration as that of the above-mentioned negative electrode of the present technology, and includes, for example, a negative electrode current collector 34A and a negative electrode active substance layer 34B, as illustrated in FIG. 9. The configuration of each of the positive electrode current collector 33A, the positive electrode active substance layer 33B, the negative electrode current collector 34A, and the negative electrode active substance layer 34B are, for example, the same as the configuration of each of the positive electrode current collector 21A, the positive electrode active substance layer 21B, the negative electrode current collector 22A, and the negative electrode active substance layer 22B. The configuration of the separator 35 is, for example, the same as the configuration of the separator 23.

### (Electrolyte Layer)

The electrolyte layer 36 contains an electrolytic solution and a polymer compound. The electrolytic solution has the same configuration as the electrolytic solution used in the above-mentioned cylindrical secondary battery. The electrolyte layer 36 described here is a so-called gel electrolyte, and in the electrolyte layer 36, the electrolytic solution is held by the polymer compound. This is because high ionic conductivity (for example, 1 mS/cm or more at room temperature) can be obtained, and leakage of the electrolytic solution can be prevented. The electrolyte layer 36 may further contain any one or two or more types of other material such as additives.

The polymer compound contains any one or two or more types of a homopolymer and a copolymer. The homopolymer is, for example, polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, methyl polymethacrylate, polyacrylic, polymethacrylate, styrene-butadiene rubber, nitrile-butadiene rubber, polystyrene, or polycarbonate. The copolymer is, for example, a copolymer of vinylidene fluoride and hexafluoropyrene. In particular, the homopolymer is preferably polyvinylidene fluoride, and the copolymer is preferably a copolymer of vinylidene fluoride and hexafluoropyrene. This is because it is electrochemically stable.

In the electrolyte layer 36 which is a gel electrolyte, the “solvent” contained in the electrolytic solution is a broad concept including not only liquid materials but also materials having ion conductivity capable of dissociating electrolyte salt. For this reason, in the case of using the high molecular compound which has ion conductivity, the high molecular compound is also contained in the solvent.

Instead of the electrolyte layer 36, the electrolytic solution may be used as it is. In this case, the wound electrode body 30 is impregnated with the electrolytic solution.

### [Operation]

The secondary battery operates, for example, as follows.

At the time of charging, lithium ions are released from the positive electrode 33, and the lithium ions are occluded in the negative electrode 34 through the electrolyte layer 36. On the other hand, at the time of discharge, lithium ions are released from the negative electrode 34, and the lithium ions are occluded in the positive electrode 33 through the electrolyte layer 36.

### [Manufacturing Method]

The secondary battery provided with the gel electrolyte layer 36 is manufactured, for example, by the following three types of procedures.

In the first procedure, the positive electrode 33 and the negative electrode 34 are produced by the same procedures as the production procedures of the positive electrode 21 and the negative electrode 22. Specifically, in the case of producing the positive electrode 33, the positive electrode active substance layers 33B are formed on both sides of the positive electrode current collector 33A, and in the case of producing the negative electrode 34, the negative electrode active substance layers 34B are formed on both sides of the negative electrode current collector 34A. Subsequently, an electrolytic solution, a polymer compound, an organic solvent, and the like are mixed to prepare a precursor solution. Subsequently, the precursor solution is coated on the positive electrode 33, and then the precursor solution is dried to form the gel electrolyte layer 36. Further, the precursor solution is coated on the negative electrode 34, and then the precursor solution is dried to form the gel electrolyte layer 36. Subsequently, the positive electrode lead 31 is connected to the positive electrode current collector 33A using a welding method or the like, and the negative electrode lead 32 is connected to the negative electrode current collector 34A using a welding method or the like. Subsequently, the positive electrode 33 and the negative electrode 34 laminated via the separator 35 are wound to form the wound electrode body 30, and then the protective tape 37 is attached to the outermost periphery of the wound electrode body 30. Subsequently, the exterior member 40 is folded so as to sandwich the wound electrode body 30, and then the outer peripheral edge portions of the exterior member 40 are adhered to each other using a heat fusion method or the like, so that the wound electrode body 30 is sealed inside the exterior member 40. In this case, the close contact film 41 is inserted between the positive electrode lead 31 and the exterior member 40, and the close contact film 41 is inserted between the negative electrode lead 32 and the exterior member 40.

In the second procedure, the positive electrode lead 31 is connected to the positive electrode 33 using a welding method or the like, and the negative electrode lead 32 is connected to the negative electrode 34 using a welding method or the like. Subsequently, the positive electrode 33 and the negative electrode 34 laminated via the separator 35 are wound to produce a wound body which is a precursor of the wound electrode body 30, and then the protective tape 37 is attached to the outermost periphery of the wound body. Subsequently, the exterior member 40 is folded so as to sandwich the wound electrode body 30, and then the remaining outer peripheral edge portion excluding the outer peripheral edge portion of one side of the exterior member 40 is adhered using a heat fusion method or the like, so that the wound body is housed inside the bag-like exterior member 40. Subsequently, an electrolytic solution, a monomer which is a raw material of a polymer compound, a polymerization initiator, and, as needed, other materials such as a polymerization inhibitor are mixed to prepare a composition for an electrolyte. Subsequently, the composition for an electrolyte is injected into the inside of the bag-like exterior member 40, and then the exterior member 40 is sealed using a heat fusion method or the like. Subsequently, the monomer is thermally polymerized to form a polymer compound. As a result, the electrolytic solution is held by the polymer compound, so that the gel electrolyte layer 36 is formed.

In the third procedure, a wound body is produced in the same procedure as the second procedure described above except that the separator 35 in which the polymer compound layer is formed in the porous membrane (base material layer) is used, and then the wound body is housed inside the bag-like exterior member 40. Subsequently, an electrolytic solution is injected into the inside of the bag-like exterior member 40, and then the opening portion of the exterior member 40 is sealed using a heat fusion method or the like. Subsequently, the exterior member 40 is heated while applying a load to the exterior member 40, so that the separator 35 is brought into close contact with the positive electrode 33, and the separator 35 is brought into contact with the negative electrode 34. As a result, the polymer compound layer is impregnated with the electrolytic solution, and the polymer compound layer is gelated, so that the electrolyte layer 36 is formed.

In this third procedure, the secondary battery is less likely to swell as compared to the first procedure. Further, in the third procedure, since the solvent and the monomer (raw material of the polymer compound) and the like are less likely to remain in the electrolyte layer 36 as compared to the second procedure, the process of forming the polymer compound is well controlled. For this reason, each of the positive electrode 33, the negative electrode 34, and the separator 35 are sufficiently in close contact with the electrolyte layer 36.

### [Action and Effect]

According to this secondary battery, since the negative electrode 34 has the same configuration as that of the above-mentioned negative electrode for a secondary battery of the present technology, even if charge and discharge are repeated, the secondary battery is less likely to swell and the discharge capacity is less likely to be reduced. Therefore, the battery characteristics of the secondary battery can be improved.

The other actions and effects are similar to the actions and effects of the negative electrode of the present technology.

### <3. Application of Secondary Battery>

Next, application examples of the above-mentioned secondary battery will be described.

The application of the secondary battery is not particularly limited as long as the secondary battery is applied to the machines, devices, instruments, devices, and systems (aggregate of multiple devices) in which the secondary battery can be used as a driving power source or a power storage source for storing power. The secondary battery used as a power source may be a main power source or an auxiliary power source. The main power source is a power source that is preferentially used regardless of the presence or absence of other power sources. The auxiliary power source may be, for example, a power source used instead of the main power source, or a power source switched from the main power source as needed. When the secondary battery is used as an auxiliary power source, the type of main power source is not limited to the secondary battery.

The application of the secondary battery is, for example, as follows. They are electronic devices (including portable electronic devices) such as video cameras, digital still cameras, mobile phones, laptop computers, cordless phones, headphone stereos, portable radios, portable TVs, and portable information terminals. They are portable household appliances such as electric shavers. They are storage devices such as backup power sources and memory cards. They are electric tools such as electric drills and electric saws. They are battery packs mounted on a notebook computer as a removable power source. They are medical electronic devices such as pacemakers and hearing aids. They are electric vehicles such as electric cars (including hybrid cars). They are power storage systems such as household battery systems for storing power in preparation for an emergency or the like. As a matter of course, the application of the secondary battery may be applications other than the above.

In particular, it is effective that the secondary battery is applied to battery packs, electric vehicles, power storage systems, electric tools, electronic devices, and the like. Since excellent battery characteristics are required in these applications, it is possible to effectively improve the performance by using the secondary battery of the present technology. The battery packs are power sources using a secondary battery. The battery packs may use a single cell or an assembled battery as described later. The electric vehicles are vehicles that operate (travel) using a secondary battery as a driving power source, and as described above, may be cars (such as hybrid cars) also including a drive source other than the secondary battery. The power storage systems are systems using a secondary battery as a power storage source. For example, in household power storage systems, since power is stored in a secondary battery which is a power storage source, it is possible to use household electrical appliances and the like by using the power. The electric tools are tools in which a movable portion (for example, a drill or the like) moves using a secondary battery as a driving power source. The electronic devices are devices that exhibit various functions using a secondary battery as a driving power source (power supply source).

Here, some application examples of the secondary battery will be specifically described. Configurations of the application examples described below are merely examples, and the configurations of the application examples can be changed as appropriate.

### <3-1. Battery Pack (Single Cell)>

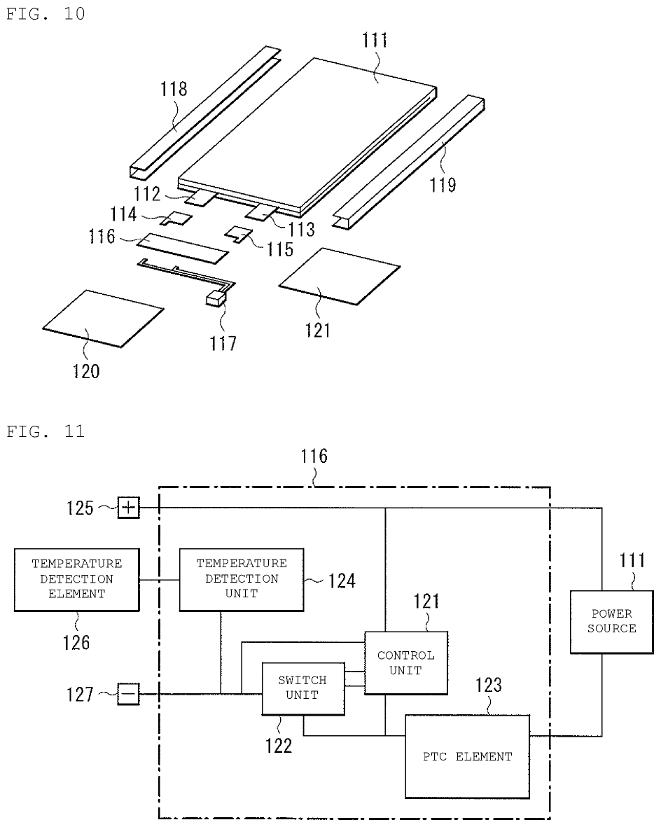

FIG. 10 illustrates a perspective configuration of a battery pack using a single cell, and FIG. 11 illustrates a block configuration of the battery pack illustrated in FIG. 10. In FIG. 10, the battery pack is illustrated in a disassembled state.

The battery pack described here is a simple battery pack (so-called soft pack) using one secondary battery of the present technology, and is mounted on, for example, an electronic device represented by a smartphone. For example, as illustrated in FIG. 10, this battery pack includes a power source 111 which is a secondary battery of laminated film type, and a circuit board 116 connected to the power source 111. A positive electrode lead 112 and a negative electrode lead 113 are attached to the power source 111.

A pair of adhesive tapes 118 and 119 are attached to both sides of the power source 111. In the circuit board 116, a protection circuit module (PCM) is formed. The circuit board 116 is connected to a positive electrode 112 through a tab 114 and connected to the negative electrode lead 113 through a tab 115. Further, the circuit board 116 is connected to the connector-attached lead wire 117 for external connection. When the circuit board 116 is connected to the power source 111, the circuit board 116 is protected by a label 120 and an insulating sheet 121. By attaching the label 120, the circuit board 116, the insulating sheet 121, and the like are fixed.

In addition, for example, as illustrated in FIG. 11, the battery pack includes the power source 111 and the circuit board 116. The circuit board 116 includes, for example, a control unit 121, a switch unit 122, a PTC element 123, and a temperature detection unit 124. The power source 111 can be connected to the outside through a positive electrode terminal 125 and a negative electrode terminal 127, so that the power source 111 is charged and discharged through the positive electrode terminal 125 and the negative electrode terminal 127. The temperature detection unit 124 detects a temperature using a temperature detection terminal (so-called T terminal) 126.

The control unit 121 controls the operation of the entire battery pack (including the usage state of the power source 111). The control unit 121 includes, for example, a central processing unit (CPU) and a memory.

For example, when the battery voltage reaches the overcharge detection voltage, the control unit 121 disconnects the switch unit 122 to prevent the charging current from flowing in the current path of the power source 111. Further, for example, when a large current flows at the time of charging, the control unit 121 cuts off the charging current by disconnecting the switch unit 122.

On the other hand, when the battery voltage reaches the overdischarge detection voltage, the control unit 121 disconnects the switch unit 122 to prevent the discharging current from flowing in the current path of the power source 111. Further, for example, when a large current flows during discharging, the control unit 121 cuts off the discharging current by disconnecting the switch unit 122.

The overcharge detection voltage is, for example, 4.2 V±0.05 V, and the overdischarge detection voltage is, for example, 2.4 V±0.1 V.

The switch unit 122 switches the use state of the power source 111, that is, the presence or absence of connection between the power source 111 and an external device, in accordance with an instruction from the control unit 121. The switch unit 122 includes, for example, a charge control switch and a discharge control switch. Each of the charge control switch and the discharge control switch is, for example, a semiconductor switch such as a field effect transistor (MOSFET) using a metal oxide semiconductor. The charging and discharging current is detected based on, for example, the ON resistance of the switch unit 122.

The temperature detection unit 124 measures the temperature of the power source 111 and outputs the measurement result of the temperature to the control unit 121. The temperature detection unit 124 includes, for example, a temperature detection element such as a thermistor. The measurement result of the temperature measured by the temperature detection unit 124 is used, for example, when the control unit 121 performs charge/discharge control during abnormal heat generation, or when the control unit 121 performs correction processing during calculation of the remaining capacity.

The circuit board 116 may not include the PTC element 123. In this case, the circuit board 116 may be additionally provided with a PTC element.

### <3-2. Battery Pack (Assembled Battery)>

FIG. 12 illustrates a block configuration of a battery pack using an assembled battery.

The battery pack includes, for example, in a housing 60, a control unit 61, a power source 62, a switch unit 63, a current measurement unit 64, a temperature detection unit 65, a voltage detection unit 66, a switch control unit 67, a memory 68, a temperature detection element 69, a current detection resistor 70, a positive electrode terminal 71, and a negative electrode terminal 72. The housing 60 contains, for example, a plastic material or the like.

The control unit 61 controls the operation of the entire battery pack (including the usage state of the power source 62). The control unit 61 includes, for example, a CPU. The power source 62 is an assembled battery including two or more secondary batteries of the present technology, and the connection form of the two or more secondary batteries may be series, parallel, or a combination of both. As one example, the power source 62 includes six secondary batteries connected with two in parallel and three in series.

The switch unit 63 switches the use state of the power source 62, that is, the presence or absence of connection between the power source 62 and an external device, in accordance with an instruction from the control unit 61. The switch unit 63 includes, for example, a charge control switch, a discharge control switch, a charging diode, and a discharging diode. Each of the charge control switch and the discharge control switch is, for example, a semiconductor switch such as a field effect transistor (MOSFET) using a metal oxide semiconductor.

The current measurement unit 64 measures the current using the current detection resistor 70 and outputs the measurement result of the current to the control unit 61. The temperature detection unit 65 measures the temperature using the temperature detection element 69, and outputs the measurement result of the temperature to the control unit 61. The measurement result of the temperature is used, for example, when the control unit 61 performs charge/discharge control during abnormal heat generation, or when the control unit 61 performs correction processing during calculation of the remaining capacity. The voltage detection unit 66 measures the voltage of the secondary battery in the power source 62, and supplies the measurement result of the analog-digital converted voltage to the control unit 61.

The switch control unit 67 controls the operation of the switch unit 63 in accordance with the signal input from each of the current measurement unit 64 and the voltage detection unit 66.

For example, when the battery voltage reaches the overcharge detection voltage, the switch control unit 67 disconnects the switch unit 63 (charge control switch) to prevent the charging current from flowing in the current path of the power source 62. As a result, the power source 62 can only perform discharge through the discharging diode. Note that, for example, when a large current flows at the time of charging, the switch control unit 67 cuts off the charging current.

Further, when the battery voltage reaches the overdischarge detection voltage, the switch control unit 67 disconnects the switch unit 63 (discharge control switch) to prevent the discharging current from flowing in the current path of the power source 62. As a result, the power source 62 can only perform charge through the charging diode. Note that, for example, when a large current flows during discharging, the switch control unit 67 cuts off the discharging current.

The overcharge detection voltage is, for example, 4.2 V±0.05 V, and the overdischarge detection voltage is, for example, 2.4 V±0.1 V.

The memory 68 includes, for example, an EEPROM which is a non-volatile memory. In the memory 68, for example, numerical values calculated by the control unit 61, information of the secondary battery measured in the manufacturing process stage (for example, internal resistance in an initial state), and the like are stored. The full charge capacity of the secondary battery is stored in the memory 68, so that the control unit 61 can grasp information such as the remaining capacity.

The temperature detection element 69 measures the temperature of the power source 62 and outputs the measurement result of the temperature to the control unit 61. The temperature detection element 69 includes, for example, a thermistor.

Each of the positive electrode terminal 71 and the negative electrode terminal 72 is terminal to be connected to an external device (for example, a laptop personal computer) operated by using a battery pack, an external device (for example, a charger or the like) used for charging the battery pack, and the like. The power source 62 is charged and discharged through the positive electrode terminal 71 and the negative electrode terminal 72.

### <3-3. Electric Vehicle>

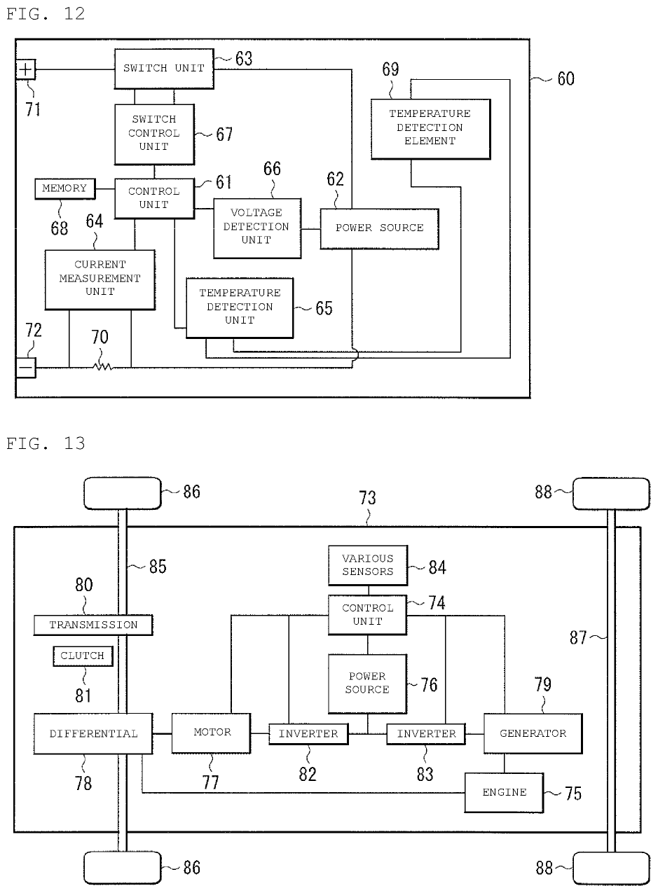

FIG. 13 illustrates a block configuration of a hybrid car which is an example of the electric vehicle.

The electric vehicle includes, for example, in a metal housing 73, a control unit 74, an engine 75, a power source 76, a driving motor 77, a differential 78, a generator 79, a transmission 80, a clutch 81, inverters 82 and 83, and various sensors 84. Besides, the electric-powered vehicle includes, for example, a front wheel drive shaft 85 connected to the differential 78 and the transmission 80, front wheels 86, a rear wheel drive shaft 87, and rear wheels 88.

The electric vehicle can travel, for example, using any one of the engine 75 and the motor 77 as a drive source. The engine 75 is a main power source, and is, for example, a gasoline engine. In the case of using the engine 75 as a power source, for example, the driving force (rotational force) of the engine 75 is transmitted to the front wheels 86 and the rear wheels 88 through the differential 78 as a driving unit, the transmission 80, and the clutch 81. Since the rotational force of engine 75 is transmitted to the generator 79, the generator 79 generates AC power using the rotational force, and the AC power is converted to DC power through the inverter 83. Therefore, the DC power is stored in the power source 76. On the other hand, in the case of using the motor 77 which is a conversion unit as a power source, the power (DC power) supplied from the power source 76 is converted into AC power through the inverter 82. Therefore, the motor 77 drives using the AC power. The driving force (rotational force) converted from the power by the motor 77 is transmitted to the front wheels 86 and the rear wheels 88 through, for example, the differential 78 as a driving unit, the transmission 80, and the clutch 81.

When the electric vehicle decelerates through the braking mechanism, the resistance at the time of deceleration is transmitted to the motor 77 as a rotational force. Therefore, the motor 77 may generate AC power using the rotational force. Since this AC power is converted to DC power through inverter 82, the DC regenerative power is preferably stored in the power source 76.

The control unit 74 controls the operation of the entire electric vehicle. The control unit 74 includes, for example, a CPU. The power source 76 includes one or two or more secondary batteries of the present technology. The power source 76 may be connected to an external power source and may store power by receiving power supply from the external power source. The various sensors 84 are used, for example, to control the rotational speed of the engine 75 and to control the opening degree of a throttle valve (throttle opening degree). The various sensors 84 include, for example, any one or two or more types of a speed sensor, an acceleration sensor, an engine speed sensor, and the like.

Although the case where the electric vehicle is a hybrid car has been described as an example, the electric vehicle may be a vehicle (electric car) that operates using only the power source 76 and the motor 77 without using the engine 75.

### <3-4. Power Storage System>

FIG. 14 illustrates a block configuration of the power storage system.

The power storage system includes, for example, a control unit 90, a power source 91, a smart meter 92, and a power hub 93 inside a house 89 such as a home or a commercial building.

Here, the power source 91 can be connected to, for example, an electric device 94 installed inside the house 89 and to an electric vehicle 96 stopped outside the house 89. Further, the power source 91 can be connected to, for example, an in-house generator 95 installed in the house 89 through the power hub 93 and to an external centralized power system 97 through the smart meter 92 and the power hub 93.

The electric device 94 includes, for example, one or two or more home appliances, and the home appliances are, for example, a refrigerator, an air conditioner, a television, and a water heater. The in-house generator 95 includes, for example, any one or two or more types of a solar power generator, a wind power generator, and the like. The electric vehicle 96 includes, for example, any one or two or more types of an electric car, an electric bike, a hybrid car, and the like. The centralized power system 97 includes, for example, any one or two or more types of a thermal power plant, a nuclear power plant, a hydroelectric power plant, a wind power plant, and the like.

The control unit 90 controls the operation of the entire power storage system (including the usage state of the power source 91). The control unit 90 includes, for example, a CPU. The power source 91 includes one or two or more secondary batteries of the present technology. The smart meter 92 is, for example, a network compatible power meter installed in the house 89 on the power demand side, and can communicate with the power source side. Along with this, the smart meter 92 enables highly efficient and stable energy supply by controlling the balance between the demand and supply of power in the house 89 while communicating with the outside, for example.

In the power storage system, for example, power is stored in the power source 91 from the centralized power system 97 which is an external power source through the smart meter 92 and the power hub 93, and power is stored in the power source 91 from the in-house generator 95 which is an independent power source through the power hub 93. The power stored in the power source 91 is supplied to the electric device 94 and the electric vehicle 96 in accordance with the instruction of the control unit 90, so that the electric device 94 can be operated and the electric vehicle 96 can be charged. That is, the power storage system is a system that enables storage and supply of power in the house 89 using the power source 91.

The power stored in the power source 91 can be used as needed. For this reason, for example, it is possible to store power from the centralized power system 97 in the power source 91 at midnight while the electricity charge is low, and to use the power accumulated in the power source 91 in the daytime while the electricity charge is high.

In addition, the above-mentioned power storage system may be installed for every one house (one household), and may be installed for every two or more houses (plural households).

### <3-5. Electric Tool>

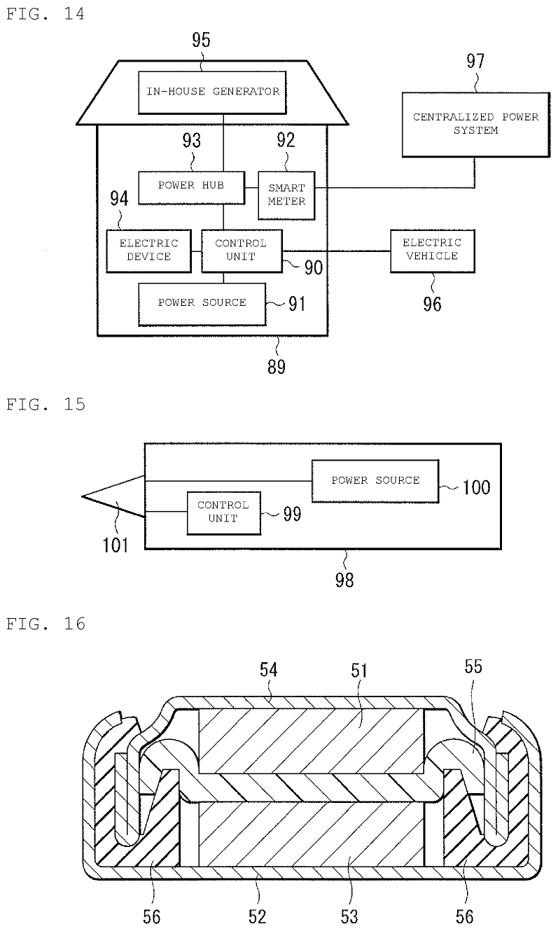

FIG. 15 illustrates a block configuration of the electric tool.

The electric tool described here is, for example, an electric drill. The electric tool includes, for example, a control unit 99 and a power source 100 inside a tool body 98. For example, a drill portion 101 which is a movable portion is attached to the tool body 98 so as to be operable (rotatable).

The tool body 98 contains, for example, a plastic material or the like. The control unit 99 controls the operation of the entire electric tool (including the usage state of the power source 100). The control unit 99 includes, for example, a CPU. The power source 100 includes one or two or more secondary batteries of the present technology. The control unit 99 supplies power from the power source 100 to the drill portion 101 in response to the operation of the operation switch.

### EXAMPLES

Examples of the present technology will be described. The description order is as follows.

1. Production and evaluation of secondary battery (conductive substance: carbon material)

2. Production and evaluation of secondary battery (conductive substance: metal material)

### <1. Preparation and Evaluation of Secondary Battery (Conductive Substance: Carbon Material)>

### Examples 1-1 to 1-38

### [Preparation of Secondary Battery]

The lithium ion secondary battery of laminated film type illustrated in FIG. 8 and FIG. 9 was produced using a carbon material as a conductive substance by the procedure described below.

### (Production of Positive Electrode)

In the case of producing the positive electrode 33, first, 95 parts by mass of a positive electrode active substance (lithium cobaltate), 3 parts by mass of a positive electrode binder (polyvinylidene fluoride), and 2 parts by mass of a positive electrode conductive agent (ketjen black which is amorphous carbon powder) were mixed to obtain a positive electrode mixture. Subsequently, the positive electrode mixture was charged into an organic solvent (N-methyl-2-pyrrolidone), and then the organic solvent was stirred to form paste-like positive electrode mixture slurry. Subsequently, the positive electrode mixture slurry was coated on both sides of the positive electrode current collector 33A (aluminum foil having a thickness of 10 μm) using a coating apparatus, and then the positive electrode mixture slurry was dried with hot air to form the positive electrode active substance layer 33B. Finally, the positive electrode active substance layer 33B was compression-molded using a roll press machine, and then the positive electrode current collector 33A on which the positive electrode active substance layer 33B was formed was cut into strips (width=70 mm, length=800 mm).

### (Production of Negative Electrode)

In the case of producing the negative electrode 34, first, the central portion 201 (silicon-based material), an aqueous solution of a salt compound (aqueous solution of polyacrylate and aqueous solution of carboxymethylcellulose salt), a conductive substance (carbon material), and an aqueous solvent (pure water) were mixed, and then the mixture was stirred. As a result, an aqueous dispersion liquid containing the central portion 201, the salt compound, and the conductive substance was obtained.

As the silicon-based material, a single substance of silicon (Si: median diameter D50=3 μm) and an alloy of silicon (SiTi_{0.01}: median diameter D50=3 μm) were used. Lithium polyacrylate (LPA), sodium polyacrylate (SPA), and potassium polyacrylate (KPA) were used as polyacrylate. Carboxymethylcellulose lithium (CMCL) was used as carboxymethylcellulose salt. As the conductive substance (carbon material), carbon nanotubes (CNT1, VGCF-H manufactured by Showa Denko K.K., average tube diameter=about 150 nm), carbon nanotubes (CNT2, CNTs 10 manufactured by ShenZhen SUSN Sinotech New Materials Co., Ltd., average tube diameter=about 10 nm), carbon nanofibers (CNF, LB200 manufactured by Cnano Technology, average fiber diameter=about 10 nm to 15 nm), carbon black (CB, EC300J manufactured by LION SPECIALTY CHEMICALS CO., Ltd.), acetylene black (AB, HS-100 manufactured by Denka Company Limited), and single-walled carbon nanotubes (SWCNT, TUBALL (registered trademark) manufactured by OCSiAl, average tube diameter=about 1 nm to 2 nm) were used. That is, carbon nanotubes, carbon nanofibers, and single-walled carbon nanotubes were used as the fibrous carbon material.

In addition, in the case of preparing an aqueous dispersion liquid, for the comparison, the aqueous solution of a salt compound and the conductive substance were not used. Further, for comparison, an aqueous solution of a non-salt compound was used instead of the aqueous solution of a salt compound. Polyacrylic (PA) and carboxymethylcellulose (CMC) were used as a non-salt compound.

The composition of the aqueous dispersion liquid, that is, the mixing ratio (% by weight), the ratios W1 and W2 (% by weight), and the ratio of the ratios W1/W2 of the series of materials used to prepare the aqueous dispersion liquid are as shown in Table 1 and Table 2. In the case of preparing the aqueous dispersion liquid, each of the ratios W1 and W2 and the ratio of the ratios W1/W2 was adjusted by changing the mixing ratio of the aqueous solution of a salt compound, the mixing ratio of the conductive substance, and the like. However, in Table 1 and Table 2, only the ratio of the ratios W1/W2 regarding some experimental examples is shown.

TABLE 1
Conductive substance: Carbon material

| | Central portion | | | | | | | | | |
|---|---|---|---|---|---|---|---|---|---|---|
| | (Silicon-based | | Salt compound | | Conductive | | | | | |
| | material) | | Non-salt compound | | substance | | | | | |
| Experimental | | Mixing | | Mixing | | Mixing | | | | |
| Example | Type | ratio | Type | ratio | Type | ratio | W1 | W2 | W1/W2 | S2/S1 |
| 1-1 | Si | 96.9 | LPA | 0.1 | CNT1 | 3 | 0.1 | 3.1 | — | — |
| 1-2 | Si | 96.5 | LPA | 0.5 | CNT1 | 3 | 0.5 | 3.1 | — | — |
| 1-3 | Si | 96 | LPA | 1 | CNT1 | 3 | 1 | 3.1 | — | — |
| 1-4 | Si | 92 | LPA | 5 | CNT1 | 3 | 5.4 | 3.3 | — | — |
| 1-5 | Si | 87 | LPA | 10 | CNT1 | 3 | 11.5 | 3.4 | — | — |
| 1-6 | Si | 82 | LPA | 15 | CNT1 | 3 | 18.3 | 3.7 | — | — |
| 1-7 | Si | 77 | LPA | 20 | CNT1 | 3 | 26 | 3.9 | — | — |
| 1-8 | Si | 92 | SPA | 5 | CNT1 | 3 | 5.4 | 3.3 | — | — |
| 1-9 | Si | 92 | KPA | 5 | CNT1 | 3 | 5.4 | 3.3 | — | — |
| 1-10 | Si | 92 | CMCL | 5 | CNT1 | 3 | 5.4 | 3.3 | — | — |
| 1-11 | SiTi_{0.01} | 92 | LPA | 5 | CNT1 | 3 | 5.4 | 3.3 | — | — |
| 1-12 | SiTi_{0.01} | 92 | CMCL | 5 | CNT1 | 3 | 5.4 | 3.3 | — | — |
| 1-13 | Si | 94.9 | LPA | 5 | CNT1 | 0.1 | 5.3 | 0.1 | — | — |
| 1-14 | Si | 94 | LPA | 5 | CNT1 | 1 | 5.3 | 1.1 | — | — |
| 1-15 | Si | 85 | LPA | 5 | CNT1 | 10 | 5.9 | 11.8 | — | — |
| 1-16 | Si | 80 | LPA | 5 | CNT1 | 15 | 6.3 | 18.8 | — | — |
| 1-17 | Si | 92 | LPA | 5 | CNT2 | 3 | 5.4 | 3.3 | 1.6 | 0.53 |
| 1-18 | Si | 92 | LPA | 5 | CNF | 3 | 5.4 | 3.3 | — | — |
| 1-19 | Si | 92 | LPA | 5 | CB | 3 | 5.4 | 3.3 | — | — |
| 1-20 | Si | 92 | LPA | 5 | AB | 3 | 5.4 | 3.3 | — | — |

TABLE 2
Conductive substance: Carbon material

| | Central portion | | | | | | | | | |
|---|---|---|---|---|---|---|---|---|---|---|
| | (Silicon-based | | Salt compound | | Conductive | | | | | |
| | material) | | Non-salt compound | | substance | | | | | |
| Experimental | | Mixing | | Mixing | | Mixing | | | | |
| Example | Type | ratio | Type | ratio | Type | ratio | W1 | W2 | W1/W2 | S2/S1 |
| 1-21 | Si | 94.999 | LPA | 5 | SWCNT | 0.001 | 5.3 | 0.001 | 5000 | 0.91 |
| 1-22 | Si | 94.9 | LPA | 5 | SWCNT | 0.1 | 5.3 | 0.1 | 50 | 0.83 |
| 1-23 | Si | 94 | LPA | 5 | SWCNT | 1 | 5.3 | 1.1 | 4.8 | 0.77 |
| 1-24 | Si | 98.999 | LPA | 1 | SWCNT | 0.001 | 1 | 0.001 | 1000 | 0.84 |
| 1-25 | Si | 97.99 | LPA | 2 | SWCNT | 0.01 | 2 | 0.01 | 200 | 0.81 |
| 1-25 | Si | 98.99 | LPA | 1 | SWCNT | 0.01 | 1 | 0.01 | 100 | 0.80 |
| 1-27 | Si | 98.9 | LPA | 1 | SWCNT | 0.1 | 1 | 0.1 | 10 | 0.77 |
| 1-28 | Si | 98 | LPA | 1 | SWCNT | 1 | 1 | 1.02 | 1 | 0.71 |
| 1-29 | Si | 99.8 | LPA | 0.1 | SWCNT | 0.1 | 0.1 | 0.1 | 1 | 0.43 |
| 1-30 | Si | 91.9 | LPA | 5 | SWCNT + | 0.1 + | 5.4 | 3.4 | — | — |
| | | | | | CB | 3 | | | | |
| 1-31 | Si | 100 | — | — | — | — | — | — | — | — |
| 1-32 | Si | 92 | PA | 5 | CNT1 | 3 | 5.4 | 3.3 | — | — |
| 1-33 | Si | 92 | CMC | 5 | CNT1 | 3 | 5.4 | 3.3 | — | — |

Subsequently, the aqueous dispersion liquid was sprayed using a spray drying apparatus (manufactured by Fujisaki Electric Co., Ltd.), and then the aqueous dispersion liquid was dried. As a result, the covering portion 202 including the salt compound and the conductive substance was formed to cover the surface of the central portion 201, so that the first negative electrode active substance 200 including the central portion 201 and the covering portion 202 was obtained. In addition, the composite grain 200C was formed because the plurality of first negative electrode active substances 200 were in close contact with each other due to the use of the spray drying method as a method of forming the first negative electrode active substance 200.

Here, in the case of forming the composite grain 200C using a salt compound, the composite grain 200C was observed using a transmission electron microscope. As a result, when the fibrous carbon material (CNT2, CNF, and SWCNT) having a small average fiber diameter was used as the conductive substance, the three-dimensional network structure illustrated in FIG. 4 was observed. On the other hand, when the fibrous carbon material (CNT 1) having a large average fiber diameter was used as the conductive substance, the above-mentioned three-dimensional network structure was not observed. That is, when the fibrous carbon material having an average fiber diameter in an appropriate range was used as the conductive substance, the plurality of first negative electrode active substances 200 were connected to each other using the connection portion 203 including the fiber portion 204 and the protective portion 205 to form the three-dimensional network structure. The cross-sectional area ratio S2/S1 is as shown in Table 1 and Table 2. In the case of forming the composite grain 200C (three-dimensional network structure), the cross-sectional area ratio S2/S1 was adjusted by the same method as in the case of adjusting the ratio of the ratios W1/W2 or the like. However, in Table 1 and Table 2, only the cross-sectional area ratio S2/S1 regarding some experiment examples is shown.

Subsequently, the first negative electrode active substance 200 described above, the second negative electrode active substance 300 (mesocarbon microbeads (MCMB) which is a carbon-based material, median diameter D50=21 μm), a negative electrode binder, a negative electrode conductive agent (fibrous carbon), and a non-aqueous solvent (N-methyl-2-pyrrolidone) were mixed, and then the mixture was kneaded and stirred using a rotation and revolution mixer. As a result, a non-aqueous dispersion liquid containing the first negative electrode active substance 200, the second negative electrode active substance 300, the negative electrode binder, and the negative electrode conductive agent was obtained.

Polyvinylidene fluoride (PVDF), polyimide (PI), and aramid (AR) were used as the negative electrode binder.

The composition of the non-aqueous dispersion liquid, that is, the mixing ratio (% by weight) of the series of materials used to prepare the non-aqueous dispersion liquid is as shown in Table 3 to Table 5. The mixing ratio of the negative electrode conductive agent was 1% by weight.

TABLE 3
Conductive substance: Carbon material

| | First negative electrode active material | | | | | | | | Second negative | | | | | | |
|---|---|---|---|---|---|---|---|---|---|---|---|---|---|---|---|
| | Central | | | | | | Connec- | | electrode active | | Negative | | | | |
| Experi- | portion | Covering portion | | | | | tion | | material | | electrode | | Cycle | Load | |
| mental | Silicon- | Salt | Conduc- | | | | portion | | Carbon- | | binder | | mainte- | mainte- | |
| Exam- | based | com- | tive | | | W1/ | S2/ | Mixing | based | Mixing | | Mixing | nance | nance | Initial |
| ple | material | pound | substance | W1 | W2 | W2 | S1 | ratio | material | ratio | Type | ratio | rate | rate | capacity |
| 1-1 | Si | LPA | CNT1 | 0.1 | 3.1 | — | — | 10 | MCMB | 86 | PVDF | 3 | 120 | 117 | 99.7 |
| 1-2 | Si | LPA | CNT1 | 0.5 | 3.1 | — | — | 10 | MCMB | 86 | PVDF | 3 | 120 | 117 | 99.5 |
| 1-3 | Si | LPA | CNT1 | 1 | 3.1 | — | — | 10 | MCMB | 86 | PVDF | 3 | 134 | 129 | 99.5 |
| 1-4 | Si | LPA | CNT1 | 5.4 | 3.3 | — | — | 10 | MCMB | 86 | PVDF | 3 | 140 | 136 | 98.2 |
| 1-5 | Si | LPA | CNT1 | 11.5 | 3.4 | — | — | 10 | MCMB | 86 | PVDF | 3 | 140 | 133 | 97.1 |
| 1-6 | Si | LPA | CNT1 | 18.3 | 3.7 | — | — | 10 | MCMB | 86 | PVDF | 3 | 134 | 123 | 96 |
| 1-7 | Si | LPA | CNT1 | 26 | 3.9 | — | — | 10 | MCMB | 86 | PVDF | 3 | 123 | 111 | 93.8 |
| 1-8 | Si | SPA | CNT1 | 5.4 | 3.3 | — | — | 10 | MCMB | 86 | PVDF | 3 | 137 | 117 | 98.2 |
| 1-9 | Si | KPA | CNT1 | 5.4 | 3.3 | — | — | 10 | MCMB | 86 | PVDF | 3 | 134 | 118 | 98.1 |
| 1-10 | Si | CMCL | CNT1 | 5.4 | 3.3 | — | — | 10 | MCMB | 86 | PVDF | 3 | 137 | 117 | 98 |
| 1-11 | SiTi_{0.01} | LPA | CNT1 | 5.4 | 3.3 | — | — | 10 | MCMB | 86 | PVDF | 3 | 142 | 136 | 98.3 |
| 1-12 | SiTi_{0.01} | CMCL | CNT1 | 5.4 | 3.3 | — | — | 10 | MCMB | 86 | PVDF | 3 | 140 | 117 | 98.3 |
| 1-13 | Si | LPA | CNT1 | 5.3 | 0.1 | — | — | 10 | MCMB | 86 | PVDF | 3 | 130 | 132 | 98.8 |
| 1-14 | Si | LPA | CNT1 | 5.3 | 1.1 | — | — | 10 | MCMB | 86 | PVDF | 3 | 138 | 135 | 98.5 |
| 1-15 | Si | LPA | CNT1 | 5.9 | 11.8 | — | — | 10 | MCMB | 86 | PVDF | 3 | 142 | 137 | 96.4 |
| 1-16 | Si | LPA | CNT1 | 6.3 | 18.8 | — | — | 10 | MCMB | 86 | PVDF | 3 | 142 | 137 | 95.2 |

TABLE 4
Conductive substance: Carbon material

| | First negative electrode active material | | | | | | | | Second negative | | | | | | |
|---|---|---|---|---|---|---|---|---|---|---|---|---|---|---|---|
| | Central | | | | | | Connec- | | electrode active | | Negative | | | | |
| Experi- | portion | Covering portion | | | | | tion | | material | | electrode | | Cycle | Load | |
| mental | Silicon- | Salt | Conduc- | | | | portion | | Carbon- | | binder | | mainte- | mainte- | |
| Exam- | based | com- | tive | | | W1/ | S2/ | Mixing | based | Mixing | | Mixing | nance | nance | Initial |
| ple | material | pound | substance | W1 | W2 | W2 | S1 | ratio | material | ratio | Type | ratio | rate | rate | capacity |
| 1-17 | Si | LPA | CNT2 | 5.4 | 3.3 | 1.6 | 0.53 | 10 | MCMB | 86 | PVDF | 3 | 141 | 137 | 98.2 |
| 1-18 | Si | LPA | CNF | 5.4 | 3.3 | — | — | 10 | MCMB | 86 | PVDF | 3 | 139 | 135 | 98.2 |
| 1-19 | Si | LPA | CB | 5.4 | 3.3 | — | — | 10 | MCMB | 86 | PVDF | 3 | 137 | 134 | 98 |
| 1-20 | Si | LPA | AB | 5.4 | 3.3 | — | — | 10 | MCMB | 86 | PVDF | 3 | 138 | 134 | 98.1 |
| 1-21 | Si | LPA | SWCNT | 5.3 | 0.001 | 5000 | 0.91 | 10 | MCMB | 86 | PVDF | 3 | 132 | 135 | 99.3 |
| 1-22 | Si | LPA | SWCNT | 5.3 | 0.1 | 50 | 0.83 | 10 | MCMB | 86 | PVDF | 3 | 144 | 138 | 99.3 |
| 1-23 | Si | LPA | SWCNT | 5.3 | 1.1 | 4.8 | 0.77 | 10 | MCMB | 86 | PVDF | 3 | 144 | 138 | 99 |
| 1-24 | Si | LPA | SWCNT | 1 | 0.001 | 1000 | 0.84 | 10 | MCMB | 86 | PVDF | 3 | 131 | 128 | 99.9 |
| 1-25 | Si | LPA | SWCNT | 2 | 0.01 | 200 | 0.81 | 10 | MCMB | 86 | PVDF | 3 | 141 | 136 | 100.1 |
| 1-26 | Si | LPA | SWCNT | 1 | 0.01 | 100 | 0.80 | 10 | MCMB | 86 | PVDF | 3 | 143 | 137 | 100.5 |
| 1-27 | Si | LPA | SWCNT | 1 | 0.1 | 10 | 0.77 | 10 | MCMB | 86 | PVDF | 3 | 145 | 139 | 102 |
| 1-28 | Si | LPA | SWCNT | 1 | 1.02 | 1 | 0.71 | 10 | MCMB | 86 | PVDF | 3 | 145 | 139 | 101.6 |
| 1-29 | Si | LPA | SWCNT | 0.1 | 0.1 | 1 | 0.43 | 10 | MCMB | 86 | PVDF | 3 | 126 | 120 | 100.2 |
| 1-30 | Si | LPA | SWCNT + | 5.4 | 3.4 | — | — | 10 | MCMB | 86 | PVDF | 3 | 145 | 138 | 99 |
| | | | CB | | | | | | | | | | | | |

TABLE 5
Conductive substance: Carbon material

| | First negative electrode active material | | | | | | | | Second negative | | | | | | |
|---|---|---|---|---|---|---|---|---|---|---|---|---|---|---|---|
| | Central | | | | | | Connec- | | electrode active | | Negative | | | | |
| Experi- | portion | Covering portion | | | | | tion | | material | | electrode | | Cycle | Load | |
| mental | Silicon- | Salt | Conduc- | | | | portion | | Carbon- | | binder | | mainte- | mainte- | |
| Exam- | based | com- | tive | | | W1/ | S2/ | Mixing | based | Mixing | | Mixing | nance | nance | Initial |
| ple | material | pound | substance | W1 | W2 | W2 | S1 | ratio | material | ratio | Type | ratio | rate | rate | capacity |
| 1-34 | Si | LPA | CNT1 | 5.4 | 3.3 | — | — | 10 | MCMB | 86 | PI | 3 | 143 | 129 | 98.3 |
| 1-35 | Si | LPA | CNT1 | 5.4 | 3.3 | — | — | 10 | MCMB | 86 | AR | 3 | 140 | 129 | 98.2 |
| 1-36 | Si | LPA | CNF | 5.4 | 3.3 | — | — | 5 | MCMB | 91 | PVDF | 3 | 148 | 139 | 93.3 |
| 1-37 | Si | LPA | CNF | 5.4 | 3.3 | — | — | 20 | MCMB | 76 | PVDF | 3 | 125 | 113 | 116.8 |
| 1-38 | Si | LPA | CNF | 5.4 | 3.3 | — | — | 40 | MCMB | 56 | PVDF | 3 | 106 | 103 | 160.3 |
| 1-31 | Si | — | — | — | — | — | — | 10 | MCMB | 86 | PVDF | 3 | 100 | 100 | 100 |
| 1-32 | Si | PA | CNT1 | 5.4 | 3.3 | — | — | 10 | MCMB | 86 | PVDF | 3 | 95 | 92 | 97.8 |
| 1-33 | Si | CMC | CNT1 | 5.4 | 3.3 | — | — | 10 | MCMB | 86 | PVDF | 3 | 99 | 92 | 97.5 |

Subsequently, the non-aqueous dispersion liquid was coated on both sides of the negative electrode current collector 34A (copper foil having a thickness of 8 μm) using a coating apparatus, and then the non-aqueous dispersion liquid was dried with hot air to form the negative electrode active substance layer 34B Finally, the negative electrode active substance layer 34B was compression-molded using a roll press machine, and then the negative electrode current collector 34A on which the negative electrode active substance layer 34B was formed was cut into strips (width=72 mm, length=810 mm).

### (Preparation of Electrolytic Solution)

In the case of preparing the electrolytic solution, the electrolyte salt (LiPF₆) is add to the solvent (ethylene carbonate and ethyl methyl carbonate), so that the solvent was stirred. In this case, the mixing ratio (weight ratio)

of the solvent was set so to ethylene carbonate: ethyl methyl carbonate=50:50. The content of the electrolyte salt was set to 1 mol/dm³ (=1 mol/1) with respect to the solvent.

### (Assembly of Secondary Battery)

In the case of assembling the secondary battery, first, the positive electrode lead 31 made of aluminum was welded to the positive electrode current collector 33A, and the negative electrode lead 32 made of copper was welded to the negative electrode current collector 34A. Subsequently, the positive electrode 33 and the negative electrode 34 were laminated via the separator 35 (microporous polyethylene film having a thickness of 25 μm) to obtain a laminate. Subsequently, the laminate was wound in the longitudinal direction, and then the protective tape 37 was attached to the outermost periphery of the laminate to produce the wound electrode body 30. Subsequently, the exterior member 40 was folded so as to sandwich the wound electrode body 30, and then the outer peripheral edge portions of three sides of the exterior member 40 were fused with heat. As the exterior member 40, an aluminum laminated film in which a nylon film having a thickness of 25 μm, an aluminum foil having a thickness of 40 μm, and a polypropylene film having a thickness of 30 μm were laminated in this order from the outside was used. In this case, the close contact film 41 was inserted between the positive electrode lead 31 and the exterior member 40, and the close contact film 41 was inserted between the negative electrode lead 32 and the exterior member 40. Finally, the electrolytic solution was injected into the inside of the exterior member 40 to impregnate the wound electrode body 30 with the electrolytic solution, and then the outer peripheral edge portions of the remaining one side of the exterior member 40 were fused with heat in a reduced-pressure environment.

As a result, the wound electrode body 30 was sealed inside the exterior member 40, so that a lithium ion secondary battery of laminated film type was completed.

### [Design of Secondary Battery]

In the case of producing the secondary battery, each of the thickness of the positive electrode active substance layer 33B and the thickness of the negative electrode active substance layer 34B was adjusted so that the capacity ratio was 0.9. The calculation procedure of the capacity ratio is as follows.

FIG. 16 illustrates a cross-sectional configuration of a test secondary battery (coin type). In the secondary battery, a test electrode 51 is accommodated inside an exterior cup 54, and a counter electrode 53 is accommodated inside an exterior can 52. The test electrode 51 and the counter electrode 53 are stacked via a separator 55, and the exterior can 52 and the exterior cup 54 are crimped with a gasket 56. Each of the test electrode 51, the counter electrode 53, and the separator 55 is impregnated with an electrolytic solution.

In the case of designing the capacity ratio, first, a test electrode 51 in which a positive electrode active substance layer was formed on one side of a positive electrode current collector was produced. Subsequently, the coin-type secondary battery illustrated in FIG. 16 was produced using lithium metal as the counter electrode 53 together with the test electrode 51. The respective configurations of the positive electrode current collector, the positive electrode active substance layer, and the separator 55 are the same as the respective configurations of the positive electrode current collector 33A, the positive electrode active substance layer 33B, and the separator 35 used in the secondary battery of laminated film type described above. Further, the composition of the electrolytic solution was the same as the composition of the electrolytic solution used in the secondary battery of laminated film type. Subsequently, the secondary battery was charged to measure the electric capacity, and then the charge capacity (charge capacity of the positive electrode) per thickness of the positive electrode active substance layer was calculated. At the time of charging, constant current charging was performed with a current of 0.1 C until the voltage reached 4.4 V.

Subsequently, the charge capacity of the negative electrode was calculated by the same procedure. That is, the test electrode 51 having the negative electrode active substance layer formed on one side of the negative electrode current collector was produced, and the test electrode 51 and the counter electrode 53 (lithium metal) were used to produce the coin-type secondary battery. Then, the electrical capacity was measured by charging the secondary battery. After this, the charge capacity (charge capacity of the negative electrode) per thickness of the negative electrode active substance layer was calculated. At the time of charging, constant current charging was performed with a current of 0.1 C until the voltage reached 0 V, and then constant voltage charging was performed with a voltage of 0 V until the current reached 0.01 C.

“0.1 C” is a current value at which the battery capacity (theoretical capacity) is completely discharged in 10 hours. “0.01 C” is a current value at which the battery capacity is completely discharged in 100 hours.

Finally, based on the charge capacity of the positive electrode and the charge capacity of the negative electrode, capacity ratio=charge capacity of positive electrode/charge capacity of negative electrode was calculated.

### [Evaluation of Battery Characteristics]

The cycle characteristics, load characteristics, and initial capacity characteristics were examined as battery characteristics of the secondary battery, and the results shown in Tables 3 to 5 were obtained.

In the case of examining the cycle characteristics, first, in order to stabilize the battery state, the secondary battery was charged and discharged for one cycle in a normal temperature environment (23° C.). Subsequently, the discharge capacity of the second cycle was measured by charging and discharging the secondary battery again in the same environment for one cycle. Subsequently, the discharge capacity of the 100th cycle was measured by repeatedly charging and discharging the secondary battery until the total number of cycles reached 100 cycles in the same environment. Finally, cycle maintenance rate (%)=(discharge capacity at 100th cycle/discharge capacity at second cycle)×100 was calculated.

At the first cycle of charging, charging was performed with a current of 0.2 C until the voltage reached 4.35 V, and further, charging was performed with a voltage of 4.35 V until the current reached 0.025 C. At the first cycle of discharge, discharging was performed with a current of 0.2 C until the voltage reached 3 V.

At the charging after the second cycle, charging was performed with a current of 0.5 C until the voltage reached 4.35 V, and further, charging was performed with a voltage of 4.35 V until the current reached 0.025 C. At the charging after the second cycle, discharging was performed with a current of 0.5 C until the voltage reached 3 V.

“0.2 C” is a current value at which the battery capacity (theoretical capacity) is completely discharged in 5 hours. “0.025 C” is a current value at which the battery capacity is completely discharged in 40 hours. “0.5 C” is a current value at which the battery capacity is completely discharged in 2 hours.

In Tables 3 to 5, values standardized with the values of the cycle maintenance rate in Experimental examples 1-31 being 100 are indicated as the values of the cycle maintenance rate in Experimental examples 1-1 to 1-30 and 1-32 to 1-38.

In the case of examining the load characteristics, using a secondary battery (having been charged and discharged for one circle) whose battery state is stabilized, the secondary battery is further charged and discharged for three cycles while changing the current of during discharging in a normal temperature environment (23° C.) by the same procedure as in the case of examining the cycle characteristics. In this manner, the discharge capacity was measured in each of the second cycle and the fourth cycle. From this measurement result, the load maintenance rate (%)=(discharge capacity at fourth cycle/discharge capacity at second cycle)×100 was calculated.

At each of the second to forth cycles of charging, charging was performed with a current of 0.2 C until the voltage reached 4.35 V, and further, charging was performed with a voltage of 4.35 V until the current reached 0.025 C. At the second cycle of discharge, discharging was performed with a current of 0.2 C until the voltage reached 3 V. At the third cycle of discharge, discharging was performed with a current of 0.5 C until the voltage reached 3 V. At the fourth cycle of discharge, discharging was performed with a current of 2 C until the voltage reached 3 V. “2 C” is a current value at which the battery capacity is completely discharged in 0.5 hours.

In Tables 3 to 5, values standardized with the values of the load maintenance rate in Experimental examples 1-31 being 100 are indicated as the values of the load maintenance rate in Experimental examples 1-1 to 1-30 and 1-32 to 1-38.

In the case of examining the initial capacity characteristics, the above-mentioned coin-type secondary battery was produced using the negative electrode 34 as the test electrode 51, and then the initial capacity was measured by charging and discharging the secondary battery. The configuration of the secondary battery other than the configuration of the test electrode 51 is as described above. The charge conditions of the coin-type secondary battery are as described above. During discharging, discharging was performed with a current of 0.1 C until the voltage reached 1.5 V.

In Tables 3 to 5, values standardized with the values of the initial capacity in Experimental examples 1-31 being 100 are indicated as the values of the initial capacity in Experimental examples 1-1 to 1-30 and 1-32 to 1-38.

### [Discussion of Evaluation Results]

As shown in Tables 3 to 5, each of the cycle maintenance rate, the load maintenance rate, and the initial capacity largely fluctuated according to the configuration of the negative electrode 34.

Specifically, in the case where, even though the covering portion 202 was provided on the surface of the central portion 201, the covering portion 202 contained the conductive substance together with the non-salt compound (Experimental examples 1-32 and 1-33), each of the cycle maintenance rate, the load maintenance rate, and the initial capacity decreased as compared with the case where the covering portion 202 was not provided (Experimental Example 1-31).

On the other hand, in the case where the covering portion 202 was provided on the surface of the central portion 201 and the covering portion 202 contained the conductive substance together with the salt compound (Experimental Examples 1-1 to 1-30 and 1-34 to 1-38), each of the cycle maintenance rate and the load maintenance rate increased while the decrease in the initial capacity was minimized as compared with the case where the covering portion 202 was not provided (experimental example 1-31). This result was similarly obtained independently of the type of silicon-based material, the type of salt compound, the type of conductive substance, and the type of negative electrode binder.

In particular, the following tendency was obtained when the covering portion 202 contained the conductive substance together with the salt compound.

First, when the ratio W1 was 0.1% by weight or more and less than 20% by weight, each of the load maintenance rate and the initial capacity further increased while a high cycle maintenance rate was maintained.

Second, in the case where the carbon nanotubes or the like were used as the conductive substance (carbon material), when the ratio W2 was 0.1% by weight or more and less than 15% by weight, the initial capacity further increased while a high cycle maintenance rate and a high load maintenance rate were maintained.

Third, in the case where the single-walled carbon nanotubes were used as the conductive substance (carbon material), when the ratio W2 was 0.001% by weight or more and less than 1% by weight, the initial capacity further increased while a high cycle maintenance rate and a high load maintenance rate were maintained.

Fourth, by using the fibrous carbon material (single-walled carbon nanotubes or the like) having an average fiber diameter of 0.1 nm to 50 nm as the conductive substance (carbon material), the plurality of first negative electrode active substances 200 were connected to each other via the plurality of connection portions 203, so that the composite grain 200C having a three-dimensional network structure was formed.

Fifth, in the case where the three-dimensional network structure was formed, when the ratio of the ratios W1/W2 satisfied W1/W2≤200 and the cross-sectional area ratio S2/S1 satisfied S2/S1≥0.5, each of the cycle maintenance rate and the load maintenance rate further increased while a high initial capacity was maintained.

The reason why these results were obtained is considered to be as follows.

When the covering portion 202 containing the non-salt compound and the conductive substance (carbon material) is provided on the surface of the central portion 201, the covering portion 202 functions as a protective film and a binder. As a result, the surface of the central portion 201 is protected from the electrolytic solution by the covering portion 202, and the central portions 201 are bonded to each other via the covering portions 202. In addition, since the electrical resistance of the covering portion 202 is reduced due the fact that the carbon material which is a conductive substance is contained, the electrical resistance of the first negative electrode active substance 200 becomes difficult to be increased. Therefore, even if charge and discharge are repeated, the decomposition reaction of the electrolytic solution due to the reactivity of the surface of central portion 201 is suppressed, and the collapse of the negative electrode active substance layer 34B due to expansion and contraction of central portion 201 is suppressed.

However, since a non-salt compound is weakly acidic, polymer chains are likely to aggregate in the non-salt compound. In this case, since the surface of the central portion 201 is sufficiently covered with the non-salt compound, the electrolytic solution is likely to be decomposed on the surface of the central portion 201. Thus, both the cycle maintenance rate and the load maintenance rate are reduced. Besides, a weakly acidic non-salt compound corrodes devices used to manufacture secondary batteries. In addition, a non-salt compound swells excessively due to the heat generated in the manufacturing process of the secondary battery, so they are significantly degraded.

On the other hand, unlike the non-salt compound described above, the salt compound is not acidic, and therefore, the polymer chains are less likely to aggregate in the salt compound. In this case, since the surface of the central portion 201 is easily covered with the salt compound, the electrolytic solution is not easily decomposed on the surface of the central portion 201. Thus, both the cycle maintenance rate and the load maintenance rate are increased. As a matter of course, in this case, the apparatus is less likely to be corroded, and significant deterioration of the salt compound is also prevented. In addition, since the coating film of the salt compound contains a conductive substance, the discharge capacity is unlikely to be reduced even if charge and discharge are repeated.

In particular, when the three-dimensional network structure is formed in the case of using a salt compound, the plurality of first negative electrode active substances 200 are firmly bonded to each other, and the conductivity is improved between the plurality of first negative electrode active substances 200. Thus, each of the cycle maintenance rate and the load maintenance rate are sufficiently increased.

### <2. Production and Evaluation of Secondary Battery (Conductive Substance: Metal Material)>

### Experimental Examples 2-1 to 2-55

As shown in Tables 6 to 12, a secondary battery was produced by the same procedure except that a metal material is used instead of the carbon material as the conductive substance, and then the battery characteristics of the secondary battery (cycle characteristics, load characteristics, and initial capacity characteristics) were examined.

As metal material, powder of each of tin (Sn, manufactured by SIGMA-ALDRICH, median diameter D50=150 nm), aluminum (Al, manufactured by Kojundo Chemical Lab. Co., Ltd., median diameter D50=150 nm), germanium (Ge, manufactured by SIGMA-ALDRICH, median diameter D50=150 nm), copper (Cu, manufactured by Kojundo Chemical Lab. Co., Ltd., median diameter D50=150 nm), and nickel (Ni, manufactured by Kojundo Chemical Lab. Co., Ltd., median diameter D50=150 nm) was used. In addition, in the case of using the metal material, the median diameter D50 was adjusted to become the above-mentioned value by pulverizing the metal material as appropriate.

The composition of the aqueous dispersion liquid prepared using the metal material as the conductive substance, that is, the mixing ratio (% by weight) of the series of materials used to prepare the aqueous dispersion liquid, and the ratios W1 and W3 are as shown in Table 6 and Table 7. In the case of preparing the aqueous dispersion liquid, each of the ratios W1 and W3 was adjusted by changing the mixing ratio of the aqueous solution of a salt compound, the mixing ratio of the conductive substance, and the like.

TABLE 6
Conductive substance: Metal material

| | Central portion | | | | | | | |
|---|---|---|---|---|---|---|---|---|
| | (Silicon-based | | Salt compound | | Conductive | | | |
| | material) | | Non-salt compound | | substance | | | |
| Experimental | | Mixing | | Mixing | | Mixing | | |
| Example | Type | ratio | Type | ratio | Type | ratio | W1 | W3 |
| 2-1 | Si | 94.91 | LPA | 0.5 | Sn | 0.09 | 5.3 | 0.1 |
| 2-2 | Si | 94.82 | LPA | 0.5 | Sn | 0.18 | 5.3 | 0.2 |
| 2-3 | Si | 94.51 | LPA | 0.5 | Sn | 0.49 | 5.3 | 0.5 |
| 2-4 | Si | 91.9 | LPA | 0.5 | Sn | 3.1 | 5.3 | 3.3 |
| 2-5 | Si | 90.1 | LPA | 0.5 | Sn | 4.9 | 5.3 | 5 |
| 2-6 | Si | 85.2 | LPA | 0.5 | Sn | 9.8 | 5.3 | 10 |
| 2-7 | Si | 94.92 | LPA | 0.5 | Al | 0.08 | 5.3 | 0.1 |
| 2-8 | Si | 94.81 | LPA | 0.5 | Al | 0.19 | 5.3 | 0.2 |
| 2-9 | Si | 94.52 | LPA | 0.5 | Al | 0.48 | 5.3 | 0.5 |
| 2-10 | Si | 91.8 | LPA | 0.5 | Al | 3.2 | 5.3 | 3.3 |
| 2-11 | Si | 90.2 | LPA | 0.5 | Al | 4.8 | 5.3 | 5 |
| 2-12 | Si | 85.1 | LPA | 0.5 | Al | 9.9 | 5.3 | 10 |
| 2-13 | Si | 94.91 | LPA | 0.5 | Ge | 0.09 | 5.3 | 0.1 |
| 2-14 | Si | 94.81 | LPA | 0.5 | Ge | 0.19 | 5.3 | 0.2 |
| 2-15 | Si | 94.52 | LPA | 0.5 | Ge | 0.48 | 5.3 | 0.5 |
| 2-16 | Si | 91.9 | LPA | 0.5 | Ge | 3.1 | 5.3 | 3.3 |
| 2-17 | Si | 90.1 | LPA | 0.5 | Ge | 4.9 | 5.3 | 5 |
| 2-18 | Si | 85.3 | LPA | 0.5 | Ge | 9.7 | 5.3 | 10 |
| 2-19 | Si | 94.92 | LPA | 0.5 | Cu | 0.08 | 5.3 | 0.1 |
| 2-20 | Si | 94.82 | LPA | 0.5 | Cu | 0.18 | 5.3 | 0.2 |
| 2-21 | Si | 94.53 | LPA | 0.5 | Cu | 0.47 | 5.3 | 0.5 |
| 2-22 | Si | 91.9 | LPA | 0.5 | Cu | 3.1 | 5.3 | 3.3 |
| 2-23 | Si | 90.2 | LPA | 0.5 | Cu | 4.8 | 5.3 | 5 |
| 2-24 | Si | 85.1 | LPA | 0.5 | Cu | 9.9 | 5.3 | 10 |

TABLE 7
Conductive substance: Metal material

| | Central portion | | | | | | | |
|---|---|---|---|---|---|---|---|---|
| | (Silicon-based | | Salt compound | | Conductive | | | |
| | material) | | Non-salt compound | | substance | | | |
| Experimental | | Mixing | | Mixing | | Mixing | | |
| Example | Type | ratio | Type | ratio | Type | ratio | W1 | W3 |
| 2-25 | Si | 94.92 | LPA | 5 | Ni | 0.08 | 5.3 | 0.1 |
| 2-26 | Si | 94.81 | LPA | 5 | Ni | 0.19 | 5.3 | 0.2 |
| 2-27 | Si | 94.51 | LPA | 5 | Ni | 0.49 | 5.3 | 0.5 |
| 2-28 | Si | 91.9 | LPA | 5 | Ni | 3.1 | 5.3 | 3.3 |
| 2-29 | Si | 90.2 | LPA | 5 | Ni | 4.8 | 5.3 | 5 |
| 2-30 | Si | 85.2 | LPA | 5 | Ni | 9.8 | 5.3 | 10 |
| 2-31 | Si | 96.8 | SPA | 0.1 | Sn | 3.1 | 0.1 | 3.3 |
| 2-32 | Si | 96.7 | SPA | 0.2 | Sn | 3.1 | 0.2 | 3.3 |
| 2-33 | Si | 91.7 | SPA | 5.2 | Sn | 3.1 | 5.3 | 3.3 |
| 2-34 | Si | 85.6 | SPA | 11.3 | Sn | 3.1 | 12 | 3.3 |
| 2-35 | Si | 82.4 | SPA | 14.5 | Sn | 3.1 | 15 | 3.3 |
| 2-36 | Si | 78 | SPA | 18.9 | Sn | 3.1 | 20 | 3.3 |
| 2-37 | Si | 96.7 | KPA | 0.1 | Sn | 3.2 | 0.1 | 3.3 |
| 2-38 | Si | 96.6 | KPA | 0.2 | Sn | 3.2 | 0.2 | 3.3 |
| 2-39 | Si | 91.7 | KPA | 5.1 | Sn | 3.2 | 5.3 | 3.3 |
| 2-40 | Si | 85.4 | KPA | 11.4 | Sn | 3.2 | 12 | 3.3 |
| 2-41 | Si | 82.1 | KPA | 14.7 | Sn | 3.2 | 15 | 3.3 |
| 2-42 | Si | 77.7 | KPA | 19.1 | Sn | 3.2 | 20 | 3.3 |
| 2-43 | Si | 96.8 | CMCL | 0.1 | Sn | 3.1 | 0.1 | 3.3 |
| 2-44 | Si | 96.7 | CMCL | 0.2 | Sn | 3.1 | 0.2 | 3.3 |
| 2-45 | Si | 91.8 | CMCL | 5.1 | Sn | 3.1 | 5.3 | 3.3 |
| 2-46 | Si | 85.7 | CMCL | 11.2 | Sn | 3.1 | 12 | 3.3 |
| 2-47 | Si | 82.3 | CMCL | 14.6 | Sn | 3.1 | 15 | 3.3 |
| 2-48 | Si | 77.8 | CMCL | 19.1 | Sn | 3.1 | 20 | 3.3 |
| 2-49 | Si | 92 | PA | 5 | Sn | 3 | 5.3 | 3.3 |
| 2-50 | Si | 91.8 | CMC | 5.1 | Sn | 3.1 | 5.3 | 3.3 |

The composition of the non-aqueous dispersion liquid prepared using the metal material as the conductive substance, that is, the mixing ratio (% by weight) of the series of materials used to prepare the non-aqueous dispersion liquid is as shown in Table 8 to Table 12.

TABLE 8
Conductive substance: Metal material

| | First negative electrode active material | | | | | | Second negative | | | | | | |
|---|---|---|---|---|---|---|---|---|---|---|---|---|---|
| | Central | | | | | | electrode active | | Negative | | | | |
| | portion | | | | | | material | | electrode | | | | |
| | Silicon- | Covering portion | | | | | Carbon- | | binder | | Cycle | Load | |
| Experimental | based | Salt | Conductive | | | Mixing | based | Mixing | | Mixing | maintenance | maintenance | Initial |
| Example | material | compound | substance | W1 | W3 | ratio | material | ratio | Type | ratio | rate | rate | capacity |
| 2-1 | Si | LPA | Sn | 5.3 | 0.1 | 10 | MCMB | 86 | PVDF | 3 | 135 | 134 | 98.7 |
| 2-2 | Si | LPA | Sn | 5.3 | 0.2 | 10 | MCMB | 86 | PVDF | 3 | 136 | 135 | 98.8 |
| 2-3 | Si | LPA | Sn | 5.3 | 0.5 | 10 | MCMB | 86 | PVDF | 3 | 143 | 136 | 99.7 |
| 2-4 | Si | LPA | Sn | 5.3 | 3.3 | 10 | MCMB | 86 | PVDF | 3 | 141 | 137 | 99.6 |
| 2-5 | Si | LPA | Sn | 5.3 | 5 | 10 | MCMB | 86 | PVDF | 3 | 137 | 133 | 99 |
| 2-6 | Si | LPA | Sn | 5.3 | 10 | 10 | MCMB | 86 | PVDF | 3 | 136 | 132 | 98.9 |
| 2-7 | Si | LPA | Al | 5.3 | 0.1 | 10 | MCMB | 86 | PVDF | 3 | 136 | 132 | 98.7 |
| 2-8 | Si | LPA | Al | 5.3 | 0.2 | 10 | MCMB | 86 | PVDF | 3 | 137 | 133 | 98.8 |
| 2-9 | Si | LPA | Al | 5.3 | 0.5 | 10 | MCMB | 86 | PVDF | 3 | 141 | 137 | 99.8 |
| 2-10 | Si | LPA | Al | 5.3 | 3.3 | 10 | MCMB | 86 | PVDF | 3 | 140 | 136 | 99.7 |
| 2-11 | Si | LPA | Al | 5.3 | 5 | 10 | MCMB | 86 | PVDF | 3 | 136 | 133 | 99 |
| 2-12 | Si | LPA | Al | 5.3 | 10 | 10 | MCMB | 86 | PVDF | 3 | 135 | 132 | 98.8 |

TABLE 9
Conductive substance: Metal material

| | First negative electrode active material | | | | | | Second negative | | | | | | |
|---|---|---|---|---|---|---|---|---|---|---|---|---|---|
| | Central | | | | | | electrode active | | Negative | | | | |
| | portion | | | | | | material | | electrode | | | | |
| | Silicon- | Covering portion | | | | | Carbon- | | binder | | Cycle | Load | |
| Experimental | based | Salt | Conductive | | | Mixing | based | Mixing | | Mixing | maintenance | maintenance | Initial |
| Example | material | compound | substance | W1 | W3 | ratio | material | ratio | Type | ratio | rate | rate | capacity |
| 2-13 | Si | LPA | Ge | 5.3 | 0.1 | 10 | MCMB | 86 | PVDF | 3 | 135 | 132 | 98.7 |
| 2-14 | Si | LPA | Ge | 5.3 | 0.2 | 10 | MCMB | 86 | PVDF | 3 | 137 | 133 | 98.8 |
| 2-15 | Si | LPA | Ge | 5.3 | 0.5 | 10 | MCMB | 86 | PVDF | 3 | 142 | 137 | 99.5 |
| 2-16 | Si | LPA | Ge | 5.3 | 3.3 | 10 | MCMB | 86 | PVDF | 3 | 140 | 136 | 99.6 |
| 2-17 | Si | LPA | Ge | 5.3 | 5 | 10 | MCMB | 86 | PVDF | 3 | 136 | 133 | 98.9 |
| 2-18 | Si | LPA | Ge | 5.3 | 10 | 10 | MCMB | 86 | PVDF | 3 | 135 | 132 | 98.7 |
| 2-19 | Si | LPA | Cu | 5.3 | 0.1 | 10 | MCMB | 86 | PVDF | 3 | 134 | 132 | 98.7 |
| 2-20 | Si | LPA | Cu | 5.3 | 0.2 | 10 | MCMB | 86 | PVDF | 3 | 135 | 133 | 98.8 |
| 2-21 | Si | LPA | Cu | 5.3 | 0.5 | 10 | MCMB | 86 | PVDF | 3 | 138 | 135 | 99.2 |
| 2-22 | Si | LPA | Cu | 5.3 | 3.3 | 10 | MCMB | 86 | PVDF | 3 | 139 | 136 | 99.3 |
| 2-23 | Si | LPA | Cu | 5.3 | 5 | 10 | MCMB | 86 | PVDF | 3 | 136 | 134 | 98.6 |
| 2-24 | Si | LPA | Cu | 5.3 | 10 | 10 | MCMB | 86 | PVDF | 3 | 135 | 133 | 98.5 |

TABLE 10
Conductive substance: Metal material

| | First negative electrode active material | | | | | | Second negative | | | | | | |
|---|---|---|---|---|---|---|---|---|---|---|---|---|---|
| | Central | | | | | | electrode active | | Negative | | | | |
| | portion | | | | | | material | | electrode | | | | |
| | Silicon- | Covering portion | | | | | Carbon- | | binder | | Cycle | Load | |
| Experimental | based | Salt | Conductive | | | Mixing | based | Mixing | | Mixing | maintenance | maintenance | Initial |
| Example | material | compound | substance | W1 | W3 | ratio | material | ratio | Type | ratio | rate | rate | capacity |
| 2-25 | Si | LPA | Ni | 5.3 | 0.1 | 10 | MCMB | 86 | PVDF | 3 | 135 | 134 | 98.6 |
| 2-26 | Si | LPA | Ni | 5.3 | 0.2 | 10 | MCMB | 86 | PVDF | 3 | 135 | 135 | 98.7 |
| 2-27 | Si | LPA | Ni | 5.3 | 0.5 | 10 | MCMB | 86 | PVDF | 3 | 139 | 136 | 99.1 |
| 2-28 | Si | LPA | Ni | 5.3 | 3.3 | 10 | MCMB | 86 | PVDF | 3 | 138 | 135 | 99.2 |
| 2-29 | Si | LPA | Ni | 5.3 | 5 | 10 | MCMB | 86 | PVDF | 3 | 136 | 134 | 98.7 |
| 2-30 | Si | LPA | Ni | 5.3 | 10 | 10 | MCMB | 86 | PVDF | 3 | 135 | 133 | 98.6 |
| 2-31 | Si | SPA | Sn | 0.1 | 3.3 | 10 | MCMB | 86 | PVDF | 3 | 135 | 114 | 98.8 |
| 2-32 | Si | SPA | Sn | 0.2 | 3.3 | 10 | MCMB | 86 | PVDF | 3 | 136 | 114 | 98.8 |
| 2-33 | Si | SPA | Sn | 5.3 | 3.3 | 10 | MCMB | 86 | PVDF | 3 | 141 | 116 | 99.5 |
| 2-34 | Si | SPA | Sn | 12 | 3.3 | 10 | MCMB | 86 | PVDF | 3 | 140 | 117 | 99.6 |
| 2-35 | Si | SPA | Sn | 15 | 3.3 | 10 | MCMB | 86 | PVDF | 3 | 137 | 114 | 98.9 |
| 2-36 | Si | SPA | Sn | 20 | 3.3 | 10 | MCMB | 86 | PVDF | 3 | 136 | 113 | 98.7 |

TABLE 11
Conductive substance: Metal material

| | First negative electrode active material | | | | | | Second negative | | | | | | |
|---|---|---|---|---|---|---|---|---|---|---|---|---|---|
| | Central | | | | | | electrode active | | Negative | | | | |
| | portion | | | | | | material | | electrode | | | | |
| | Silicon- | Covering portion | | | | | Carbon- | | binder | | Cycle | Load | |
| Experimental | based | Salt | Conductive | | | Mixing | based | Mixing | | Mixing | maintenance | maintenance | Initial |
| Example | material | compound | substance | W1 | W3 | ratio | material | ratio | Type | ratio | rate | rate | capacity |
| 2-37 | Si | KPA | Sn | 0.1 | 3.3 | 10 | MCMB | 86 | PVDF | 3 | 130 | 113 | 98.6 |
| 2-38 | Si | KPA | Sn | 0.2 | 3.3 | 10 | MCMB | 86 | PVDF | 3 | 131 | 114 | 98.6 |
| 2-39 | Si | KPA | Sn | 5.3 | 3.3 | 10 | MCMB | 86 | PVDF | 3 | 136 | 116 | 99.2 |
| 2-40 | Si | KPA | Sn | 12 | 3.3 | 10 | MCMB | 86 | PVDF | 3 | 134 | 117 | 99.3 |
| 2-41 | Si | KPA | Sn | 15 | 3.3 | 10 | MCMB | 86 | PVDF | 3 | 131 | 113 | 98.6 |
| 2-42 | Si | KPA | Sn | 20 | 3.3 | 10 | MCMB | 86 | PVDF | 3 | 130 | 112 | 98.5 |
| 2-43 | Si | CMCL | Sn | 0.1 | 3.3 | 10 | MCMB | 86 | PVDF | 3 | 134 | 113 | 98.5 |
| 2-44 | Si | CMCL | Sn | 0.2 | 3.3 | 10 | MCMB | 86 | PVDF | 3 | 136 | 114 | 98.6 |
| 2-45 | Si | CMCL | Sn | 5.3 | 3.3 | 10 | MCMB | 86 | PVDF | 3 | 141 | 117 | 99.1 |
| 2-46 | Si | CMCL | Sn | 12 | 3.3 | 10 | MCMB | 86 | PVDF | 3 | 139 | 116 | 99.2 |
| 2-47 | Si | CMCL | Sn | 15 | 3.3 | 10 | MCMB | 86 | PVDF | 3 | 137 | 113 | 98.5 |
| 2-48 | Si | CMCL | Sn | 20 | 3.3 | 10 | MCMB | 86 | PVDF | 3 | 135 | 112 | 98.4 |

TABLE 12

| | First negative electrode active material | | | | | | Second negative | | | | | | |
|---|---|---|---|---|---|---|---|---|---|---|---|---|---|
| | Central | | | | | | electrode active | | Negative | | | | |
| | portion | | | | | | material | | electrode | | | | |
| | Silicon- | Covering portion | | | | | Carbon- | | binder | | Cycle | Load | |
| Experimental | based | Salt | Conductive | | | Mixing | based | Mixing | | Mixing | maintenance | maintenance | Initial |
| Example | material | compound | substance | W1 | W3 | ratio | material | ratio | Type | ratio | rate | rate | capacity |
| 2-51 | Si | LPA | Sn | 5.3 | 3.3 | 10 | MCMB | 86 | PI | 3 | 142 | 130 | 98.5 |
| 2-52 | Si | LPA | Sn | 5.3 | 3.3 | 10 | MCMB | 86 | AR | 3 | 139 | 131 | 98.2 |
| 2-53 | Si | LPA | Sn | 5.3 | 3.3 | 5 | MCMB | 86 | PVDF | 3 | 146 | 136 | 93.1 |
| 2-54 | Si | LPA | Sn | 5.3 | 3.3 | 20 | MCMB | 86 | PVDF | 3 | 122 | 110 | 116.4 |
| 2-55 | Si | LPA | Sn | 5.3 | 3.3 | 40 | MCMB | 86 | PVDF | 3 | 103 | 101 | 160.1 |
| 1-31 | Si | — | — | — | — | 10 | MCMB | 86 | PVDF | 3 | 100 | 100 | 100 |
| 2-49 | Si | PA | Sn | 5.3 | 3.3 | 10 | MCMB | 86 | PVDF | 3 | 94 | 91 | 97.6 |
| 2-50 | Si | CMC | Sn | 5.3 | 3.3 | 10 | MCMB | 86 | PVDF | 3 | 98 | 91 | 97.3 |

In Tables 8 to 12, values standardized with the values of each of the cycle maintenance rate, the load maintenance rate, and the initial value in Experimental Example 1-31 being 100 are indicated as the values of each of the cycle maintenance rate, the load maintenance rate, and the initial capacity in Experimental Examples 2-1 to 2-55.

As shown in Tables 8 to 12, even in the case where the metal material was used as the conductive substance, the same results as in the case where the carbon material was used as the conductive substance (Tables 3 to 5) were obtained.

That is, in the case where, even though the covering portion 202 was provided on the surface of the central portion 201, the covering portion 202 contained the conductive substance together with the non-salt compound (Experimental examples 2-49 and 2-50), each of the cycle maintenance rate, the load maintenance rate, and the initial capacity decreased as compared with the case where the covering portion 202 was not provided (Experimental Example 1-31).

On the other hand, in the case where the covering portion 202 was provided on the surface of the central portion 201 and the covering portion 202 contained the conductive substance together with the salt compound (Experimental Examples 2-1 to 2-48 and 2-51 to 2-55), each of the cycle maintenance rate and the load maintenance rate increased while the decrease in the initial capacity was minimized as compared with the case where the covering portion 202 was not provided (experimental example 1-31).

In the case where the covering portion 202 contains the conductive substance together with the salt compound, in particular, when the ratio W1 was 0.1% by weight or more and less than 20% by weight, each of the load maintenance rate and the initial capacity further increased while a high cycle maintenance rate was maintained. In addition, when the ratio W3 is from 0.1% by weight to 10% by weight, a high cycle maintenance rate, a high load maintenance rate, and a high initial capacity were obtained.

The reason why these results were obtained is that the covering portion 202 containing the conductive substance (metal material) together with the salt compound also exhibits the same function as the covering portion 202 containing the conductive substance (carbon material) together with the above-mentioned salt compound.

As shown in Tables 1 to 12, when the negative electrode contains the first negative electrode active substance (central portion containing the silicon-based material, and the covering portion containing the salt compound and the conductive substance), the second negative electrode active substance (carbon-based material), and the negative electrode binder (polyvinylidene fluoride or the like), each of the cycle characteristics, the load characteristics, and the initial capacity characteristics was improved. Therefore, excellent battery characteristics were obtained in the secondary battery.

Although the present technology has been described above with reference to the embodiment and the examples, the present technology is not limited to the modes described in the embodiment and examples, and various modifications are possible.

For example, in order to explain the configuration of the secondary battery of the present technology, the case where the battery structure is a cylindrical, a laminated film type, or a coin type, and the battery element has a wound structure is taken as an example. However, the secondary battery of the present technology is applicable when the secondary battery has other battery structures such as a square type and a button type, and is also applicable when the battery element has another structure such as a laminated structure.

Further, for example, the electrolytic solution for a secondary battery according to the embodiment of the present technology is not limited to the secondary battery, and may be applied to other electrochemical devices. Other electrochemical devices are, for example, capacitors.

In addition, the effect described in this specification is an illustration to the last, is not limited, and may have other effects.

The present technology can also be configured as follows.

(1)

A secondary battery including:

a positive electrode;

a negative electrode; and

an electrolytic solution,

in which the negative electrode includes a first negative electrode active substance, a second negative electrode active substance, and a negative electrode binder,

in which the first negative electrode active substance includes a central portion containing a material containing silicon (Si) as a constituent element, and a covering portion provided on a surface of the central portion and containing a salt compound and a conductive substance,

in which the salt compound contains at least one of polyacrylate and carboxymethylcellulose salt,

in which the conductive substance contains at least one of a carbon material and a metal material,

in which the second negative electrode active substance contains a material containing carbon (C) as a constituent element, and

in which the negative electrode binder contains at least one type of polyvinylidene fluoride, polyimide, and aramid.

(2)

The secondary battery according to the above-mentioned item (1), in which the negative electrode includes a plurality of first negative electrode active substances, and further includes composite grain formed by bringing the plurality of first negative electrode active substances into close contact with each other.

(3)

The secondary battery according to the above-mentioned item (2), in which a specific surface area of the composite grain is 0.1 m²/g or more and 10 m²/g or less.

(4)

The secondary battery according to any one of the above-mentioned items (1) to (3),

in which the polyacrylate contains at least one type of lithium polyacrylate, sodium polyacrylate, and potassium polyacrylate, and

in which the carboxymethylcellulose salt contains at least one type of lithium carboxymethylcellulose, sodium carboxymethylcellulose, and potassium carboxymethylcellulose.

(5)

The secondary battery according to any one of the above-mentioned items (1) to (4), in which a ratio W1 of a weight of the salt compound contained in the covering portion to a weight of the central portion is 0.1% by weight or more and less than 20% by weight.

(6)

The secondary battery according to any one of the above-mentioned items (1) to (5), in which the carbon material includes at least one type of carbon nanotubes, carbon nanofibers, carbon black, and acetylene black.

(7)

The secondary battery according to the above-mentioned item (6), in which an average tube diameter of the carbon nanotubes is 1 nm or more and 300 nm or less.

(8)

The secondary battery according to the above-mentioned item (6) or (7), in which a ratio W2 of a weight of the carbon material contained in the covering portion as the conductive substance to a weight of the central portion is 0.1% by weight or more and less than 15% by weight.

(9)

The secondary battery according to any one of the above-mentioned items (1) to (5), in which the carbon material contains single-walled carbon nanotubes.

(10)

The secondary battery according to the above-mentioned item (9), in which an average tube diameter of the single-walled carbon nanotube is 0.1 nm or more and 5 nm or less.

(11)

The secondary battery according to the above-mentioned item (9) or (10), in which a ratio W2 of a weight of the carbon material contained in the covering portion as the conductive substance to a weight of the central portion is 0.001% by weight or more and less than 1% by weight.

(12)

The secondary battery according to any one of the above-mentioned items (1) to (5), in which the carbon material contains a fibrous carbon material,

in which an average fiber diameter of the fibrous carbon material is 0.1 nm or more and 50 nm or less,

in which the negative electrode includes a plurality of first negative electrode active substances,

in which the plurality of first negative electrode active substances are connected to each other via a plurality of connection portions which extend between the plurality of first negative electrode active substances to form a three-dimensional network structure, and

in which each of the plurality of connection portions extends between the plurality of first negative electrode active substances, and includes a fiber portion containing the fibrous carbon material, and a protective portion provided on a surface of the fiber portion and containing the salt compound.

(13)

The secondary battery according to the above-mentioned item (12), in which the fibrous carbon material contains at least one type of carbon nanotubes, carbon nanofibers, and single-walled carbon nanotubes.

(14)

The secondary battery according to the above-mentioned item (12) or (13),

in which a ratio W1 of a weight of the salt compound contained in the covering portion to a weight of the central portion and a ratio W2 of a weight of the fibrous carbon material contained in the covering portion as the conductive substance to the weight of the central portion satisfy W1/W2≤200, and

in which a cross-sectional area S1 of the connection portion in an extending direction of the connection portion and a cross-sectional area S2 of the protective portion in the extending direction of the connection portion satisfy S2/S1≥0.5.

(15)

The secondary battery according to any one of the above-mentioned items (1) to (5), in which the metal material contains at least one type of tin (Sn), aluminum (Al), germanium (Ge), copper (Cu), and nickel (Ni).

(16)

The secondary battery according to the above-mentioned item (15), in which a ratio W3 of a weight of the metal material contained in the covering portion as the conductive substance to a weight of the central portion is 0.1% by weight or more and 10% by weight or less.

(17)

The secondary battery according to any one of the above-mentioned items (1) to (16), in which the secondary battery is a lithium ion secondary battery.

(18)

A negative electrode for a secondary battery including:

a first negative electrode active substance;

a second negative electrode active substance; and

a negative electrode binder,

in which the first negative electrode active substance includes a central portion containing a material containing silicon as a constituent element, and a covering portion provided on a surface of the central portion and containing a salt compound and a conductive substance,

in which the salt compound contains at least one of polyacrylate and carboxymethylcellulose salt,

in which the conductive substance contains at least one of a carbon material and a metal material,

in which the second negative electrode active substance contains a material containing carbon as a constituent element, and

in which the negative electrode binder contains at least one type of polyvinylidene fluoride, polyimide, and aramid.

(19)

A battery pack including:

the secondary battery according to any one of the above-mentioned items (1) to (17);

a control unit that controls an operation of the secondary battery; and

a switch unit that switches the operation of the secondary battery in accordance with an instruction of the control unit.

(20)

A electric vehicle including:

the secondary battery according to any one of the above-mentioned items (1) to (17);

a conversion unit that converts power supplied from the secondary battery into a driving force;

a driving unit that performs driving operation in accordance with the driving force; and

a control unit that controls an operation of the secondary battery

(21)

A power storage system including:

the secondary battery according to any one of the above-mentioned items (1) to (17);

one or two or more electric devices to which power is supplied from the secondary battery; and

a control unit that controls the power supply from the secondary battery to the one or two or more electric devices.

(22)

An electric tool including:

the secondary battery according to any one of the above-mentioned items (1) to (17); and

a movable portion to which power is supplied from the secondary battery.

(23)

An electronic device including the secondary battery according to any one of the above-mentioned items (1) to (17) as a power supply source.

The present application claims priority based on Japanese Patent Application No. 2017-021883 filed on Feb. 9, 2017 in the Japanese Patent Office, Japanese Patent Application No. 2017-113451 filled on Jun. 8, 2017 in the Japanese Patent Office, and Japanese Patent Application No. 2017-164381 filed on Aug. 29, 2017 in the Japanese Patent Office, the entire content of which is incorporated herein by reference.

Although various modifications, combinations, sub-combinations, and modifications will be made to those skilled in the art depending on the design requirements and other factors, it is understood that those are within the spirit of the appended claims and the scope of equivalents thereof.

1. A secondary battery comprising:
a positive electrode;
a negative electrode; and
an electrolytic solution,
wherein the negative electrode includes a first negative electrode active substance, a second negative electrode active substance, and a negative electrode binder,
wherein the first negative electrode active substance includes a central portion containing a material containing silicon (Si) as a constituent element, and a covering portion provided on a surface of the central portion and containing a salt compound and a conductive substance,
wherein the salt compound contains at least one of polyacrylate and carboxymethylcellulose salt,
wherein the conductive substance contains at least one of a carbon material and a metal material,
wherein the second negative electrode active substance contains a material containing carbon (C) as a constituent element, and
wherein the negative electrode binder contains at least one type of polyvinylidene fluoride, polyimide, and aramid.

2. The secondary battery according to claim 1, wherein the negative electrode includes a plurality of first negative electrode active substances, and further includes composite grain formed by bringing the plurality of first negative electrode active substances into close contact with each other.

3. The secondary battery according to claim 2, wherein a specific surface area of the composite grain is 0.1 m²/g or more and 10 m²/g or less.

4. The secondary battery according to claim 1,
wherein the polyacrylate contains at least one type of lithium polyacrylate, sodium polyacrylate, and potassium polyacrylate, and
wherein the carboxymethylcellulose salt contains at least one type of lithium carboxymethylcellulose, sodium carboxymethylcellulose, and potassium carboxymethylcellulose.

5. The secondary battery according to claim 1, wherein a ratio W1 of a weight of the salt compound contained in the covering portion to a weight of the central portion is 0.1% by weight or more and less than 20% by weight.

6. The secondary battery according to claim 1, wherein the carbon material includes at least one type of carbon nanotubes, carbon nanofibers, carbon black, and acetylene black.

7. The secondary battery according to claim 6, wherein an average tube diameter of the carbon nanotubes is 1 nm or more and 300 nm or less.

8. The secondary battery according to claim 6, wherein a ratio W2 of a weight of the carbon material contained in the covering portion as the conductive substance to a weight of the central portion is 0.1% by weight or more and less than 15% by weight.

9. The secondary battery according to claim 1, wherein the carbon material contains single-walled carbon nanotubes.

10. The secondary battery according to claim 9, wherein an average tube diameter of the single-walled carbon nanotube is 0.1 nm or more and 5 nm or less.

11. The secondary battery according to claim 9, wherein a ratio W2 of a weight of the carbon material contained in the covering portion as the conductive substance to a weight of the central portion is 0.001% by weight or more and less than 1% by weight.

12. The secondary battery according to claim 1,
wherein the carbon material contains a fibrous carbon material,
wherein an average fiber diameter of the fibrous carbon material is 0.1 nm or more and 50 nm or less,
wherein the negative electrode includes a plurality of first negative electrode active substances,
wherein the plurality of first negative electrode active substances are connected to each other via a plurality of connection portions which extend between the plurality of first negative electrode active substances to form a three-dimensional network structure, and
wherein each of the plurality of connection portions extends between the plurality of first negative electrode active substances, and includes a fiber portion containing the fibrous carbon material, and a protective portion provided on a surface of the fiber portion and containing the salt compound.

13. The secondary battery according to claim 12, wherein the fibrous carbon material contains at least one type of carbon nanotubes, carbon nanofibers, and single-walled carbon nanotubes.

14. The secondary battery according to claim 12,
wherein a ratio W1 of a weight of the salt compound contained in the covering portion to a weight of the central portion and a ratio W2 of a weight of the fibrous carbon material contained in the covering portion as the conductive substance to the weight of the central portion satisfy W1/W2≤200, and
wherein a cross-sectional area S1 of the connection portion in an extending direction of the connection portion and a cross-sectional area S2 of the protective portion in the extending direction of the connection portion satisfy S2/S1≥0.5.

15. The secondary battery according to claim 1, wherein the metal material contains at least one type of tin (Sn), aluminum (Al), germanium (Ge), copper (Cu), and nickel (Ni).

16. The secondary battery according to claim 15, wherein a ratio W3 of a weight of the metal material contained in the covering portion as the conductive substance to a weight of the central portion is 0.1% by weight or more and 10% by weight or less.

17. A battery pack comprising:
a secondary battery;
a control unit that controls an operation of the secondary battery; and
a switch unit that switches the operation of the secondary battery in accordance with an instruction of the control unit,
wherein the secondary battery includes a positive electrode, a negative electrode, and an electrolytic solution,
wherein the negative electrode includes a first negative electrode active substance, a second negative electrode active substance, and a negative electrode binder,
wherein the first negative electrode active substance includes a central portion containing a material containing silicon as a constituent element, and a covering portion provided on a surface of the central portion and containing a salt compound and a conductive substance,
wherein the salt compound contains at least one of polyacrylate and carboxymethylcellulose salt,
wherein the conductive substance contains at least one of a carbon material and a metal material,
wherein the second negative electrode active substance contains a material containing carbon as a constituent element, and
wherein the negative electrode binder contains at least one type of polyvinylidene fluoride, polyimide, and aramid.

18. A electric vehicle comprising:
a secondary battery;
a conversion unit that converts power supplied from the secondary battery into a driving force;
a driving unit that performs driving operation in accordance with the driving force; and
a control unit that controls an operation of the secondary battery,
wherein the secondary battery includes a positive electrode, a negative electrode, and an electrolytic solution,
wherein the negative electrode includes a first negative electrode active substance, a second negative electrode active substance, and a negative electrode binder,
wherein the first negative electrode active substance includes a central portion containing a material containing silicon as a constituent element, and a covering portion provided on a surface of the central portion and containing a salt compound and a conductive substance,
wherein the salt compound contains at least one of polyacrylate and carboxymethylcellulose salt,
wherein the conductive substance contains at least one of a carbon material and a metal material,
wherein the second negative electrode active substance contains a material containing carbon as a constituent element, and
wherein the negative electrode binder contains at least one type of polyvinylidene fluoride, polyimide, and aramid.

19. An electric tool comprising:
a secondary battery; and
a movable portion to which power is supplied from the secondary battery,
wherein the secondary battery includes a positive electrode, a negative electrode, and an electrolytic solution,
wherein the negative electrode includes a first negative electrode active substance, a second negative electrode active substance, and a negative electrode binder,
wherein the first negative electrode active substance includes a central portion containing a material containing silicon as a constituent element, and a covering portion provided on a surface of the central portion and containing a salt compound and a conductive substance,
wherein the salt compound contains at least one of polyacrylate and carboxymethylcellulose salt,
wherein the conductive substance contains at least one of a carbon material and a metal material,
wherein the second negative electrode active substance contains a material containing carbon as a constituent element, and
wherein the negative electrode binder contains at least one type of polyvinylidene fluoride, polyimide, and aramid.

20. An electronic device comprising a secondary battery as a power supply source,
wherein the secondary battery includes a positive electrode, a negative electrode, and an electrolytic solution,
wherein the negative electrode includes a first negative electrode active substance, a second negative electrode active substance, and a negative electrode binder,
wherein the first negative electrode active substance includes a central portion containing a material containing silicon as a constituent element, and a covering portion provided on a surface of the central portion and containing a salt compound and a conductive substance,
wherein the salt compound contains at least one of polyacrylate and carboxymethylcellulose salt,
wherein the conductive substance contains at least one of a carbon material and a metal material,
wherein the second negative electrode active substance contains a material containing carbon as a constituent element, and
wherein the negative electrode binder contains at least one type of polyvinylidene fluoride, polyimide, and aramid.
